(19) United States
(12) Patent Application Publication
(10) Pub. No.: US 2014/0292450 A1
(43) Pub. Date: Oct. 2, 2014

(54) HIGH-FREQUENCY TRANSMISSION LINE AND ELECTRONIC DEVICE

(71) Applicant: Murata Manufacturing Co., Ltd., Nagaokakyo-shi (JP)

(72) Inventors: Noboru KATO, Nagaokakyo-shi (JP); Masahiro OZAWA, Nagaokakyo-shi (JP)

(21) Appl. No.: 14/306,264

(22) Filed: Jun. 17, 2014

Related U.S. Application Data
(63) Continuation of application No. PCT/JP2012/083967, filed on Dec. 27, 2012.

(30) Foreign Application Priority Data
Jan. 6, 2012 (JP) 2012-000987

(51) Int. Cl. H01P 3/08

(52) U.S. Cl. CPC H01P 3/08
USPC 333/238

(57) ABSTRACT

A high-frequency transmission line includes a laminate including dielectric layers, a first signal line provided on one of the dielectric layers, a second signal line crossing the first signal line when viewed in a plan view in a direction of lamination, the second signal line being positioned on the same dielectric layer as the first signal line except for a crossing portion that crosses with the first signal line, and an intermediate ground conductor provided between the first and second signal lines in the direction of lamination, so as to overlap with crossing portions of the first and second signal lines when viewed in a plan view in the direction of lamination.

This application is based on Japanese Patent Application No. 2012-000987 filed on Jan. 6, 2012, and International Application No. PCT/JP2012/083967 filed on Dec. 27, 2012, the entire content of each of which is incorporated herein by reference.

### BACKGROUND OF THE INVENTION

1. Field of the Invention

The present invention relates to high-frequency transmission lines and electronic devices, more particularly to a high-frequency transmission line for use in high-frequency signal transmission and an electronic device including the same.

2. Description of Related Art

As inventions relevant to conventional high-frequency transmission lines, signal lines described in, for example, International Patent Publication WO 2011/007660 and Japanese Patent Laid-Open Publication No. 2011-71403 are known. Each of these signal lines includes a laminate, a signal line, and two ground conductors.

The laminate is formed by laminating a plurality of flexible insulator layers. The signal line is provided in the laminate. The signal line is positioned between the two ground conductors in the direction of lamination. Accordingly, the signal line and the two ground conductors form a stripline structure. The signal lines described in International Patent Publication WO 2011/007660 and Japanese Patent Laid-Open Publication No. 2011-71403 are formed by laminates, and therefore, are thinner than the diameter of a typical coaxial cable. Accordingly, they can be disposed in a narrow space within an electronic device.

Incidentally, in some cases, it is desired to cross two signal lines such as those described in International Patent Publication WO 2011/007660 and Japanese Patent Laid-Open Publication No. 2011-71403. However, crossing two signal lines results in two laminates overlapping at a crossing portion of the two signal lines, hence a significantly increased thickness at the crossing. On the other hand, it is conceivable to provide two signal lines in a single laminate, so as to cross each other within the laminate. This results in a reduced thickness at a crossing portion of two signal lines in a laminate, but crosstalk occurs between the signal lines because the signal lines are opposed to each other.

### SUMMARY OF THE INVENTION

A high-frequency transmission line according to a preferred embodiment of the present invention includes a laminate including a plurality of dielectric layers, a first signal line provided on one of the dielectric layers, a second signal line crossing the first signal line when viewed in a plan view in a direction of lamination, the second signal line being positioned on the same dielectric layer as the first signal line except for a crossing portion that crosses with the first signal line, and an intermediate ground conductor provided between the first and second signal lines in the direction of lamination, so as to overlap with crossing portions of the first and second signal lines when viewed in a plan view in the direction of lamination.

An electronic device according to another preferred embodiment of the present invention includes a high-frequency transmission line and a housing accommodating the high-frequency transmission line. The high-frequency transmission line includes a laminate including a plurality of dielectric layers, a first signal line provided on one of the dielectric layers, a second signal line crossing the first signal line when viewed in a plan view in a direction of lamination, the second signal line being positioned on the same dielectric layer as the first signal line except for a crossing portion that crosses with the first signal line, and an intermediate ground conductor provided between the first and second signal lines in the direction of lamination, so as to overlap with crossing portions of the first and second signal lines when viewed in a plan view in the direction of lamination.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is an external oblique view of a high-frequency transmission line according to a preferred embodiment of the present invention.

FIG. 2 is an exploded oblique view of a portion E1 of the high-frequency transmission line according to a preferred embodiment of the present invention.

FIG. 3 is an exploded oblique view of a portion E2 of the high-frequency transmission line according to a preferred embodiment of the present invention.

FIG. 4 is an exploded oblique view of a portion E3 of the high-frequency transmission line according to a preferred embodiment of the present invention.

FIG. 5 is an exploded oblique view of a connecting portion of the high-frequency transmission line according to a preferred embodiment of the present invention.

FIG. 6 is an exploded oblique view of another connecting portion of the high-frequency transmission line according to a preferred embodiment of the present invention.

FIG. 7 is a cross-sectional structure view of the portion E1 of the high-frequency transmission line according to a preferred embodiment of the present invention.

FIG. 8 is across-sectional structure view of the section E2 of the high-frequency transmission line according to a preferred embodiment of the present invention.

FIG. 9 is an external oblique view of a connector in the high-frequency transmission line.

FIG. 10 is a cross-sectional structure view of the connector in the high-frequency transmission line.

FIG. 11 illustrates an electronic device provided with the high-frequency transmission line as viewed in a plan view in the y-axis direction.

FIG. 12 illustrates the electronic device provided with the high-frequency transmission line as viewed in a plan view in the z-axis direction.

FIG. 13 is an exploded oblique view of a portion E1 of a high-frequency transmission line according to a first modification of a preferred embodiment of the present invention.

FIG. 14 is an exploded oblique view of a portion E2 of the high-frequency transmission line according to the first modification of a preferred embodiment of the present invention.

FIG. 15 is an exploded oblique view of a portion E3 of the high-frequency transmission line according to the first modification of a preferred embodiment of the present invention.

FIG. 16 is a cross-sectional structure view of a section A1 of the high-frequency transmission line according to the first modification of a preferred embodiment of the present invention.

FIG. 17 is a cross-sectional structure view of a section A2 of the high-frequency transmission line according to the first modification of a preferred embodiment of the present invention.

FIG. 18 is a cross-sectional structure view of a section A3 of the high-frequency transmission line according to the first modification of a preferred embodiment of the present invention.

FIG. 19 is a cross-sectional structure view of a section A4 of the high-frequency transmission line according to the first modification of a preferred embodiment of the present invention.

FIG. 20 is an exploded oblique view of a portion E3 of a high-frequency transmission line according to a second modification of a preferred embodiment of the present invention.

FIG. 21 is an external oblique view of a high-frequency transmission line according to a third modification of a preferred embodiment of the present invention.

FIG. 22 is an exploded oblique view of the high-frequency transmission line according to the third modification of a preferred embodiment of the present invention.

FIG. 23 is a cross-sectional structure view of the high-frequency transmission line according to the third modification of a preferred embodiment of the present invention.

FIG. 24 illustrates an electronic device provided with the high-frequency transmission line as viewed in a plan view in the z-axis direction.

### DETAILED DESCRIPTION OF THE PREFERRED EMBODIMENTS

Hereinafter, a high-frequency transmission line according to various preferred embodiments of the present invention, along with an electronic device including the high-frequency transmission line, will be described with reference to the drawings.

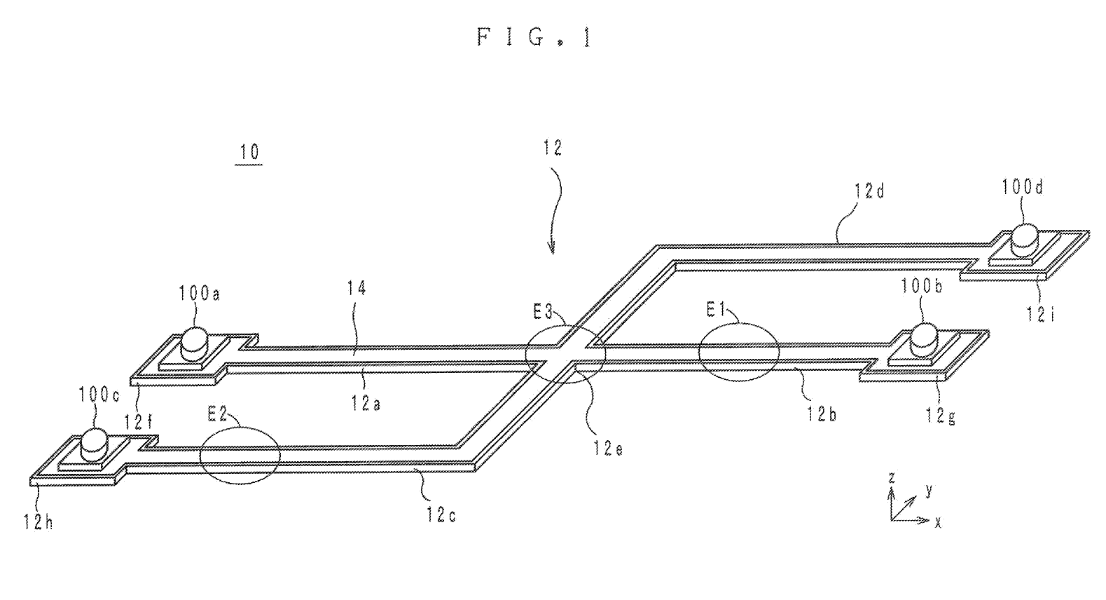

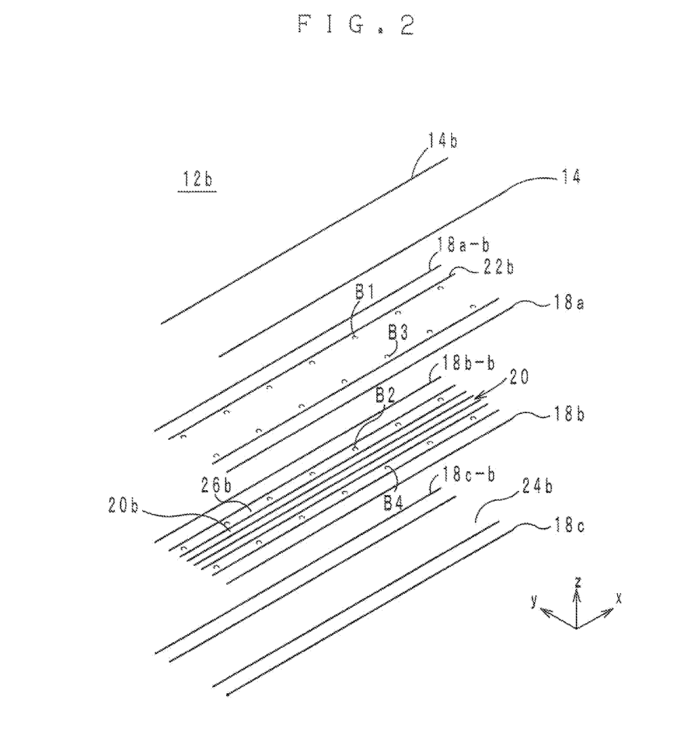

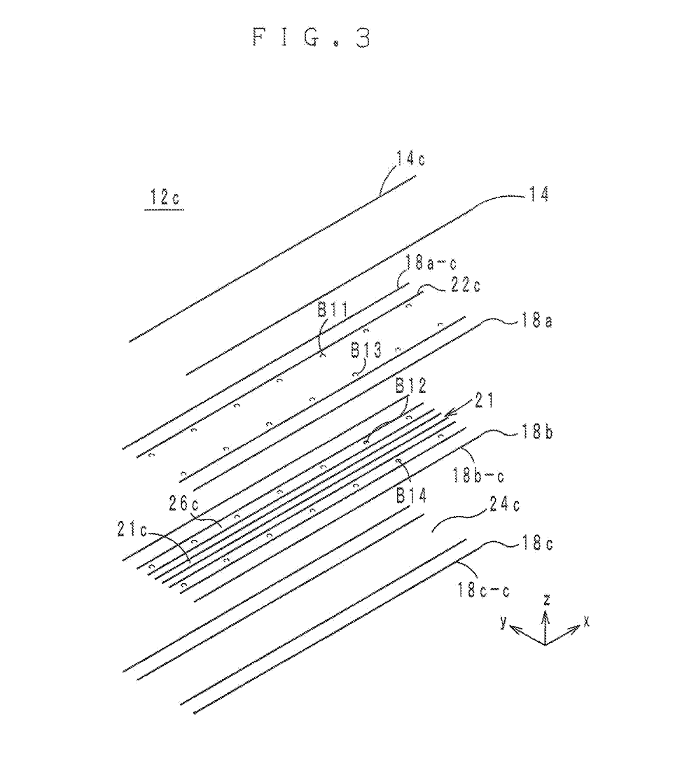

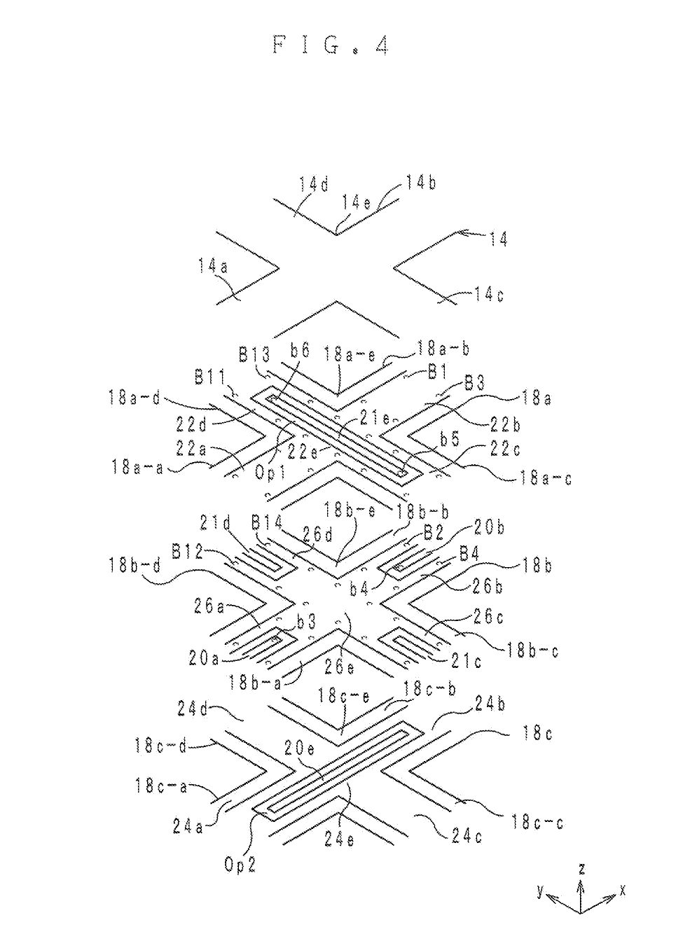

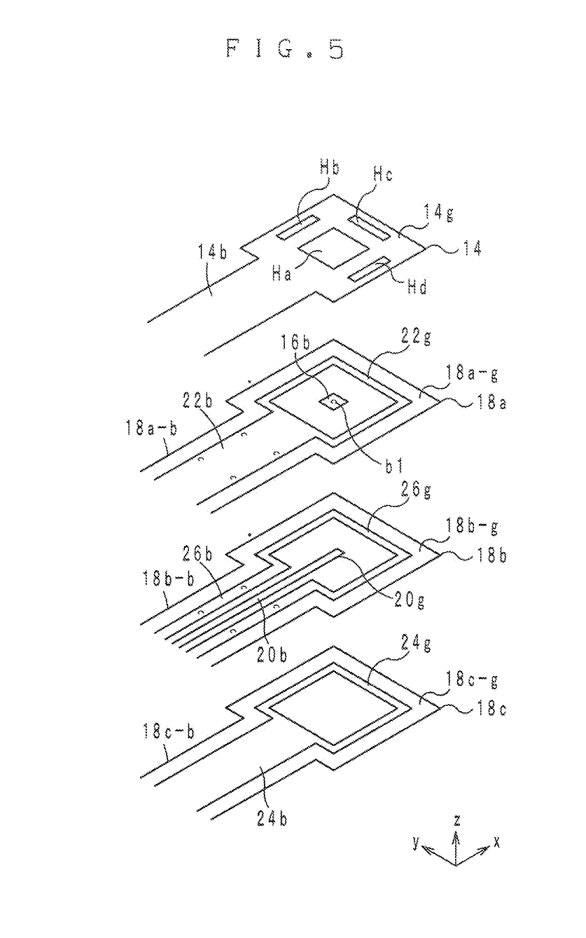

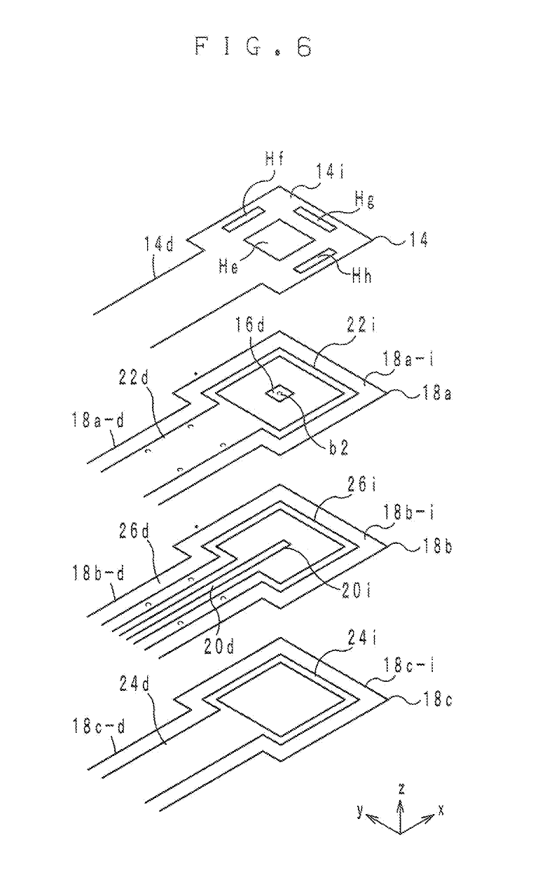

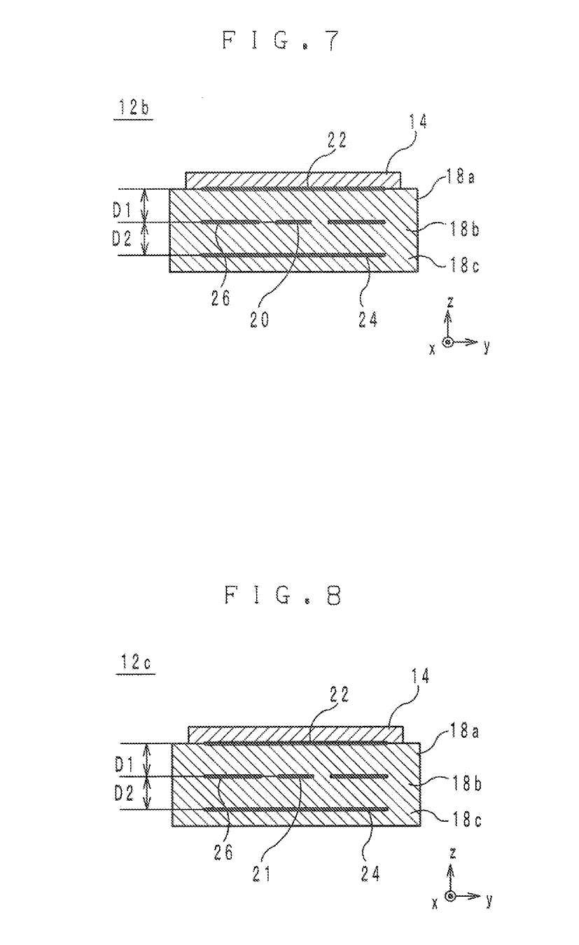

The configuration of the high-frequency transmission line according to a preferred embodiment of the present invention will be described below with reference to the drawings. FIG. 1 is an external oblique view of the high-frequency transmission line 10 according to the present preferred embodiment. FIG. 2 is an exploded oblique view of a portion E1 of the high-frequency transmission line 10 according to the present preferred embodiment. FIG. 3 is an exploded oblique view of a portion E2 of the high-frequency transmission line 10 according to the present preferred embodiment. FIG. 4 is an exploded oblique view of a portion E3 of the high-frequency transmission line 10 according to the present preferred embodiment. FIG. 5 is an exploded oblique view of a connecting portion 12g of the high-frequency transmission line 10 according to the present preferred embodiment. FIG. 6 is an exploded oblique view of a connecting portion 12i of the high-frequency transmission line 10 according to the present preferred embodiment. FIG. 7 is a cross-sectional structure view of the portion E1 of the high-frequency transmission line 10 according to the present preferred embodiment. FIG. 8 is a cross-sectional structure view of the section E2 of the high-frequency transmission line 10 according to the present preferred embodiment. In the following, the direction of lamination of the high-frequency transmission line 10 will be defined as a z-axis direction, for example. Moreover, the longitudinal direction of the high-frequency transmission line 10 will be defined as an x-axis direction, and the direction perpendicular to the x-axis and z-axis directions will be defined as a y-axis direction, for example.

As shown in FIGS. 1 through 6, the high-frequency transmission line 10 includes a dielectric element assembly 12, external terminals 16a to 16d (only the external terminals 16b and 16d are shown in the figures), signal lines 20 and 21, ground conductors 22, 24 and 26, connectors 100a to 100d, and via-hole conductors b1, b2, B1 to B4, and B11 to B14.

The dielectric element assembly 12 includes line portions 12a to 12d, a crossing portion 12e, and connecting portions 12f to 12i. The dielectric element assembly 12 is a flexible laminate preferably formed by laminating a protective layer 14 and dielectric sheets (dielectric layers) 18a to 18c in this order, from the positive side to the negative side in the z-axis direction, as shown in FIG. 2. In the following, the principal surface of the dielectric element assembly 12 that is located on the positive side in the z-axis direction will be referred to as a top surface, and the principal surface of the dielectric element assembly 12 that is located on the negative side in the z-axis direction will be referred to as a bottom surface.

The crossing portion 12e is positioned near the center of the dielectric element assembly 12 both in the x-axis direction and in the y-axis direction. The line portion 12a extends from the crossing portion 12e toward the negative side in the x-axis direction. The line portion 12b extends from the crossing portion 12e toward the positive side in the x-axis direction. The line portion 12c extends from the crossing portion 12e toward the negative side in the y-axis direction, and bends to the negative side in the x-axis direction. The line portion 12d extends from the crossing portion 12e toward the positive side in the y-axis direction, and bends to the positive side in the x-axis direction.

The connecting portion 12f preferably has a rectangular or substantially rectangular shape connected to the end of the line portion 12a that is located on the negative side in the x-axis direction. The connecting portion 12g preferably has a rectangular or substantially rectangular shape connected to the end of the line portion 12b that is located on the positive side in the x-axis direction. The connecting portion 12h preferably has a rectangular or substantially rectangular shape connected to the end of the line portion 12c that is located on the negative side in the x-axis direction. The connecting portion 12i preferably has a rectangular or substantially rectangular shape connected to the end of the line portion 12d that is located on the positive side in the x-axis direction.

The dielectric sheets 18a to 18c, when viewed in a plan view in the z-axis direction, preferably have the same shape as the dielectric element assembly 12. The dielectric sheets 18a to 18c are made of a flexible thermoplastic resin such as liquid crystal polymer or polyimide. The thickness D1 of the dielectric sheet 18a is equal or approximately equal to the thickness D2 of the dielectric sheet 18b, as shown in FIGS. 7 and 8. After lamination of the dielectric sheets 18a to 18c, the thicknesses D1 and D2 are, for example, about 50 μm to about 300 μm. In the present preferred embodiment, both of the thicknesses D1 and D2 preferably are about 150 μm, for example. In the following, the principal surface of each of the dielectric sheets 18a to 18c that is located on the positive side in the z-axis direction will be referred to as a top surface, and the principal surface of each of the dielectric sheets 18a to 18c that is located on the negative side in the z-axis direction will be referred to as a bottom surface.

Furthermore, the dielectric sheet 18a includes line portions 18a-a, 18a-b, 18a-c, and 18a-d, a crossing portion 18a-e, and connecting portions 18a-f, 18a-g, 18a-h, and 18a-i. The dielectric sheet 18b includes line portions 18b-a, 18b-b, 18b-c, and 18b-d, a crossing portion 18b-e, and connecting portions 18b-f, 18b-g, 18b-h, and 18b-i. The dielectric sheet 18c includes line portions 18c-a, 18c-b, 18c-c, and 18c-d, a crossing portion 18c-e, and connecting portions 18c-f, 18c-g, 18c-h, and 18c-i.

The line portion 12a includes line portions 18a-a, 18b-a, and 18c-a. The line portion 12b includes line portions 18a-b, 18b-b, and 18c-b. The line portion 12c includes line portions 18a-c, 18b-c, and 18c-c. The line portion 12d includes line portions 18a-d, 18b-d, and 18c-d. The crossing portion 12e includes crossing portions 18a-e, 18b-e, and 18c-e. The connecting portion 12f includes connecting portions 18a-f, 18b-f, and 18c-f. The connecting portion 12g includes connecting portions 18a-g, 18b-g, and 18c-g. The connecting portion 12h includes connecting portions 18a-h, 18b-h, and 18c-h. The connecting portion 12i includes connecting portions 18a-i, 18b-i, and 18c-i.

The signal line 20 (first signal line) is a linear conductor provided in the dielectric element assembly 12 and consisting of line conductors 20a, 20b, 20e, 20f, and 20g (the line conductor 20f is not shown in the figures) and via-hole conductors b3 and b4. The line conductors 20a and 20b extend in the x-axis direction along the top surfaces of the line portions 18b-a and 18b-b, respectively, as shown in FIGS. 2 and 4. The line conductor 20e extends in the x-axis direction along the top surface of the crossing portion 18c-e, as shown in FIG. 4. The line portions 20f and 20g extend in the x-axis direction along the top surfaces of the connecting portions 18b-f and 18b-g, respectively, as shown in FIG. 5 (only the line portion 20g is shown).

Furthermore, the via-hole conductor b3 pierces through the line portion 18b-a in the z-axis direction, as shown in FIG. 4, and connects the end of the line conductor 20a that is located on the positive side in the x-axis direction to the end of the line conductor 20e that is located on the negative side in the x-axis direction. The via-hole conductor b4 pierces through the line portion 18b-b in the z-axis direction, as shown in FIG. 4, and connects the end of the line conductor 20b that is located on the negative side in the x-axis direction to the end of the line conductor 20e that is located on the positive side in the x-axis direction.

Furthermore, the line conductor 20f (not shown) is connected to the end of the line conductor 20a that is located on the negative side in the x-axis direction. The line conductor 20g is connected to the end of the line conductor 20b that is located on the positive side in the x-axis direction, as shown in FIG. 5. Accordingly, the line conductors 20f and 20g, the via-hole conductor b3, the line conductor 20e, the via-hole conductor b4, and the line conductors 20b and 20g are connected in this order so as to define the signal line 20. Note that the signal line 20 is positioned approximately at the center in the width direction of the dielectric sheets 18. The signal line 20 as above preferably is made of a metal material mainly composed of silver or copper and having a low specific resistance, for example.

The signal line 21 (second signal line) is a linear conductor provided in the dielectric element assembly 12 and consisting of line conductors 21c, 21d, 21e, 21h, and 21i (the line conductor 21h is not shown in the figures) and via-hole conductors b5 and b6. The line conductor 21c extends along the top surface of the line portion 18b-c, as shown in FIG. 4, and more specifically, the line conductor 21c extends toward the negative side in the y-axis direction, and bends to the negative side in the x-axis direction. The line conductor 21d extends along the top surface of the line portion 18b-d, as shown in FIG. 4, and more specifically, the line conductor 21d extends toward the positive side in the y-axis direction, and bends to the positive side in the x-axis direction. The line conductor 21e extends in the y-axis direction along the top surface of the crossing portion 18a-e, as shown in FIG. 4. The line portions 21h and 21i extend in the x-axis direction along the top surfaces of the connecting portions 18b-h and 18b-i, respectively.

Furthermore, the via-hole conductor b5 pierces through the line portion 18a-c in the z-axis direction, as shown in FIG. 4, and connects the end of the line conductor 21c that is located on the positive side in the y-axis direction to the end of the line conductor 21e that is located on the negative side in the y-axis direction. The via-hole conductor b6 pierces through the line portion 18a-d in the z-axis direction, as shown in FIG. 4, and connects the end of the line conductor 21d that is located on the negative side in the y-axis direction to the end of the line conductor 21e that is located on the positive side in the y-axis direction.

Furthermore, the line conductor 21h (not shown) is connected to the end of the line conductor 21c that is located on the negative side in the x-axis direction. The line conductor 21i is connected to the end of the line conductor 21g that is located on the positive side in the x-axis direction, as shown in FIG. 6. Accordingly, the line conductors 21h and 21c, the via-hole conductor b5, the line conductor 21e, the via-hole conductor b6, and the line conductors 21d and 21i are connected in this order so as to define the signal line 21. Note that the signal line 21 is positioned approximately at the center in the width direction of the dielectric sheets 18. The signal line 21 as above preferably is made of a metal material mainly composed of silver or copper and having a low specific resistance, for example.

The signal lines 20 and 21 thus configured cross each other at the crossing portion 12e when viewed in a plan view in the z-axis direction. In addition, the portion of the signal line 20 that crosses the signal line 21 (i.e., the line conductor 20e) is positioned on the negative side in the z-axis direction relative to the portions of the signal line 20 that do not cross the signal line 21 (i.e., the line conductors 20a and 20b and the connecting conductors 20f and 20g). Similarly, the portion of the signal line 21 that crosses the signal line 20 (i.e., the line conductor 21e) is positioned on the positive side in the z-axis direction relative to the portions of the signal line 21 that do not cross the signal line 20 (i.e., the line conductors 21c and 21d and the connecting conductors 21h and 21i). That is, the signal lines 20 and 21 cross each other at positions farther away from each other in the z-axis direction than at positions where they do not cross each other.

The ground conductor 22 (first ground conductor) is provided in the dielectric element assembly 12, more specifically, on the top surface of the dielectric sheet 18a, as shown in FIGS. 2 through 6. Accordingly, the ground conductor 22 is positioned on the positive side in the z-axis direction relative to the portions where the signal lines 20 and 21 do not cross each other (i.e., the line conductors 20a, 20b, 21c, and 21d and the connecting conductors 20f, 20g, 21h, and 21i). The ground conductor 22, when viewed in a plan view in the z-axis direction, preferably has the same or approximately the same shape as the dielectric element assembly 12, and is made of a metal material mainly composed of silver or copper and having a low specific resistance, for example.

Furthermore, as shown in FIGS. 2 through 6, the ground conductor 22 includes main conductors 22a to 22d, a crossing conductor 22e, and terminal conductors 22f to 22i (the terminal conductors 22f and 22h are not shown in the figures).

The main conductors 22a to 22d and the crossing conductor 22e are positioned on the top surfaces of the line portions 18a-a to 18a-d and the crossing portion 18a-e, respectively, so as to overlap with the line conductors 20a, 20b, 21c, and 21d of the signal lines 20 and 21 when viewed in a plan view in the z-axis direction. The main conductors 22c and 22d and the crossing conductor 22e have an opening Op1 provided therein. The line conductor 21e is positioned within the opening Op1. Accordingly, the main conductors 22c and 22d and the crossing conductor 22e are not in contact with the line conductor 21e. Moreover, there is no opening other than the opening Op1 provided in the main conductors 22a to 22d. Accordingly, the main conductors 22a to 22d have no opening that overlaps with the signal lines 20 and 21. Note that the main conductors 22a to 22d are strip-shaped solid conductors extending along the line portions 18a-a to 18a-d, respectively, and connected at the crossing portion 18a-e.

The terminal conductor 22g is positioned on the top surface of the connecting portion 18a-g, and is connected to the end of the main conductor 22b that is located on the positive side in the x-axis direction, as shown in FIG. 5. The terminal conductor 22g is in the shape of a rectangular or substantially rectangular or substantially rectangular frame. The terminal conductor 22f is positioned on the top surface of the connecting portion 18a-f, and is connected to the end of the main conductor 22a that is located on the negative side in the x-axis direction. The terminal conductor 22f has the same structure as the terminal conductor 22g, and therefore, is not shown in the figure.

The terminal conductor 22i is positioned on the top surface of the connecting portion 18a-i, and is connected to the end of the main conductor 22d that is located on the positive side in the x-axis direction, as shown in FIG. 6. The terminal conductor 22i is in the shape of a rectangular or substantially rectangular or substantially rectangular frame. The terminal conductor 22h is positioned on the top surface of the connecting portion 18a-h, and is connected to the end of the main conductor 22c that is located on the negative side in the x-axis direction. The terminal conductor 22h has the same structure as the terminal conductor 22i, and therefore, is not shown in the figure.

The ground conductor 24 (second ground conductor) is provided in the dielectric element assembly 12, more specifically, on the top surface of the dielectric sheet 18c, as shown in FIGS. 2 through 6. Accordingly, the ground conductor 24 is positioned on the negative side in the z-axis direction relative to the portions where the signal lines 20 and 21 do not cross each other (i.e., the line conductors 20a, 20b, 21c, and 21d and the connecting conductors 20f, 20g, 21h, and 21i). The ground conductor 24, when viewed in a plan view in the z-axis direction, preferably has the same or approximately the same shape as the dielectric element assembly 12, and is made of a metal material mainly composed of silver or copper and having a low specific resistance, for example.

Furthermore, as shown in FIGS. 2 through 6, the ground conductor 24 includes main conductors 24a to 24d, a crossing conductor 24e, and terminal conductors 24f to 24i (the terminal conductors 24f and 24h are not shown in the figures).

The main conductors 24a to 24d and the crossing conductor 24e are positioned on the top surfaces of the line portions 18c-a to 18c-d and the crossing portion 18c-e, respectively, so as to overlap with the line conductors 20a, 20b, 21c, and 21d of the signal lines 20 and 21 when viewed in a plan view in the z-axis direction. The main conductors 24a and 24b and the crossing conductor 24e have an opening Op2 provided therein. The line conductor 20e is positioned within the opening Op2. Accordingly, the main conductors 24a and 24b and the crossing conductor 24e are not in contact with the line conductor 20e. Moreover, there is no opening other than the opening Op2 provided in the main conductors 24a to 24d. Accordingly, the main conductors 24a to 24d have no opening that overlaps with the signal lines 20 and 21. Note that the main conductors 24a to 24d are strip-shaped solid conductors extending along the line portions 18c-a to 18c-d, respectively, and connected at the crossing portion 18c-e.

The terminal conductor 24g is positioned on the top surface of the connecting portion 18c-g, and is connected to the end of the main conductor 24b that is located on the positive side in the x-axis direction, as shown in FIG. 5. The terminal conductor 24g is in the shape of a rectangular or substantially rectangular frame. The terminal conductor 24f is positioned on the top surface of the connecting portion 18c-f, and is connected to the end of the main conductor 24a that is located on the negative side in the x-axis direction. The terminal conductor 24f has the same structure as the terminal conductor 24g, and therefore, is not shown in the figure.

The terminal conductor 24i is positioned on the top surface of the connecting portion 18c-i, and is connected to the end of the main conductor 24d that is located on the positive side in the x-axis direction, as shown in FIG. 6. The terminal conductor 24i is in the shape of a rectangular or substantially rectangular frame. The terminal conductor 24h is positioned on the top surface of the connecting portion 18c-h, and is connected to the end of the main conductor 24c that is located on the negative side in the x-axis direction. The terminal conductor 24h has the same structure as the terminal conductor 24i, and therefore, is not shown in the figure.

In this manner, the line conductors 20a and 20b of the signal line 20 are sandwiched between the ground conductors 22 and 24 in the z-axis direction. Accordingly, the line conductors 20a and 20b and the ground conductors 22 and 24 define a tri-plate stripline structure. Similarly, the line conductors 21c and 21d of the signal line 21 are sandwiched between the ground conductors 22 and 24 in the z-axis direction. Accordingly, the line conductors 21c and 21d and the ground conductors 22 and 24 define a tri-plate stripline structure.

The ground conductor 26 (intermediate ground conductor) is provided in the dielectric element assembly 12, more specifically, on the top surface of the dielectric sheet 18b, as shown in FIGS. 2 through 6. The ground conductor 26, when viewed in a plan view in the z-axis direction, preferably has the same or approximately the same shape as the dielectric element assembly 12, and is made of a metal material mainly composed of silver or copper and having a low specific resistance.

Furthermore, as shown in FIGS. 2 through 6, the ground conductor 26 includes main conductors 26a to 26d, a crossing conductor 26e, and terminal conductors 26f to 26i (the terminal conductors 26f and 26h are not shown in the figures).

The main conductors 26a to 26d are pairs of linear conductors extending along the line portions 18b-a to 18b-d, respectively. More specifically, the main conductor 26a is positioned on the top surface of the line portion 18b-a, such that the pair of linear conductors are on opposite sides in the width direction of the line conductor 20a when viewed in a plan view in the z-axis direction. The main conductor 26b is positioned on the top surface of the line portion 18b-b, such that the pair of linear conductors are on opposite sides in the width direction of the line conductor 20b when viewed in a plan view in the z-axis direction. That is, the line conductors 20a and 20b are sandwiched by the main conductors 26a and 26b, respectively, in the width direction. Moreover, the main conductor 26c is positioned on the top surface of the line portion 18b-c, such that the pair of linear conductors are on opposite sides in the width direction of the line conductor 21c when viewed in a plan view in the z-axis direction. The main conductor 26d is positioned on the top surface of the line portion 18b-d, such that the pair of linear conductors are on opposite sides in the width direction of the line conductor 21d when viewed in a plan view in the z-axis direction. That is, the line conductors 21c and 21d are sandwiched by the main conductors 26c and 26d, respectively, in the width direction.

The crossing conductor 26e is positioned on the top surface of the crossing portion 18b-e. Accordingly, the crossing conductor 26e is positioned between the line conductors 20e and 21e in the z-axis direction, so as to overlap with the crossing portions of the line conductors 20e and 21e when viewed in a plan view in the z-axis direction. Moreover, the crossing conductor 26e is connected to the main conductors 26a to 26d.

The terminal conductor 26g is positioned on the top surface of the connecting portion 18b-g, and is connected to the end of the main conductor 26b that is located on the positive side in the x-axis direction, as shown in FIG. 5. The terminal conductor 26g is in the shape of a rectangular or substantially rectangular frame. The terminal conductor 26f is positioned on the top surface of the connecting portion 18b-f, and is connected to the end of the main conductor 26a that is located on the negative side in the x-axis direction. The terminal conductor 26f has the same structure as the terminal conductor 26g, and therefore, is not shown in the figure.

The terminal conductor 26i is positioned on the top surface of the connecting portion 18b-i, and is connected to the end of the main conductor 26d that is located on the positive side in the x-axis direction, as shown in FIG. 6. The terminal conductor 26i is in the shape of a rectangular or substantially rectangular frame. The terminal conductor 26h is positioned on the top surface of the connecting portion 18b-h, and is connected to the end of the main conductor 26c that is located on the negative side in the x-axis direction. The terminal conductor 26h has the same structure as the terminal conductor 26i, and therefore, is not shown in the figure.

Here, the distance D1 between the signal line 20 and the ground conductor 22 in the z-axis direction is equal or approximately equal to the distance D2 between the signal line 20 and the ground conductor 24 in the z-axis direction, as shown in FIG. 7. The distance D1 is equal or approximately equal to the thickness of the dielectric sheet 18a, and the distance D2 is equal or approximately equal to the thickness of the dielectric sheet 18b.

Furthermore, the distance D1 between the signal line 21 and the ground conductor 22 in the z-axis direction is equal or approximately equal to the distance D2 between the signal line 21 and the ground conductor 24 in the z-axis direction, as shown in FIG. 8. The distance D1 is equal or approximately equal to the thickness of the dielectric sheet 18a, and the distance D2 is equal or approximately equal to the thickness of the dielectric sheet 18b.

The external terminal 16b is a rectangular or substantially rectangular or substantially rectangular conductor provided on the top surface of the connecting portion 18a-g and surrounded by the terminal conductor 22g, as shown in FIG. 5. The external terminal 16b, when viewed in a plan view in the z-axis direction, overlaps with the end of the line conductor 20g that is located on the positive side in the x-axis direction. The external terminal 16b preferably is made of a metal material mainly composed of silver or copper and having a low specific resistance, for example. In addition, the top surface of the external terminal 16b preferably is plated with gold, for example.

The external terminal 16a is a rectangular or substantially rectangular or substantially rectangular conductor provided on the top surface of the connecting portion 18a-f and surrounded by the terminal conductor 22f. The external terminal 16a, when viewed in a plan view in the z-axis direction, overlaps with the end of the line conductor 20f that is located on the negative side in the x-axis direction. The external terminal 16a has the same structure as the external terminal 16b, and therefore, is not shown in the figure.

The external terminal 16d is a rectangular or substantially rectangular conductor provided on the top surface of the connecting portion 18a-i and surrounded by the terminal conductor 22i, as shown in FIG. 6. The external terminal 16d, when viewed in a plan view in the z-axis direction, overlaps with the end of the line conductor 20i that is located on the positive side in the x-axis direction. The external terminal 16d preferably is made of a metal material mainly composed of silver or copper and having a low specific resistance, for example. In addition, the top surface of the external terminal 16d preferably is plated with gold, for example.

The external terminal 16c is a rectangular or substantially rectangular conductor provided on the top surface of the connecting portion 18a-h and surrounded by the terminal conductor 22h. The external terminal 16c, when viewed in a plan view in the z-axis direction, overlaps with the end of the line conductor 21h that is located on the negative side in the x-axis direction. The external terminal 16c has the same structure as the external terminal 16d, and therefore, is not shown in the figure.

The via-hole conductor b1 pierces through the connecting portion 18a-g of the dielectric sheet 18a in the z-axis direction. The via-hole conductor b1 connects the external terminal 16b to the end of the signal line 20g that is located on the positive side in the x-axis direction.

Note that the external terminal 16a (not shown) and the end of the line conductor 20f that is located on the negative side in the x-axis direction are connected by a via-hole conductor. The via-hole conductor that connects the external terminal 16a (not shown) and the end of the line conductor 20f that is located on the negative side in the x-axis direction is similar to the via-hole conductor b1, and therefore, is not shown in the figure.

The via-hole conductor b2 pierces through the connecting portion 18a-i of the dielectric sheet 18a in the z-axis direction. The via-hole conductor b2 connects the external terminal 16d to the end of the line conductor 21i that is located on the positive side in the x-axis direction.

Note that the external terminal 16c (not shown) and the end of the line conductor 12h that is located on the negative side in the x-axis direction are connected by a via-hole conductor. The via-hole conductor that connects the external terminal 16c (not shown) and the end of the line conductor 21h that is located on the negative side in the x-axis direction is similar to the via-hole conductor b2, and therefore, is not shown in the figure.

The via-hole conductors B1 pierce through the line portions 18a-a and 18a-b of the dielectric sheet 18a in the z-axis direction, and, when viewed in a plan view in the z-axis direction, the via-hole conductors B1 are positioned on the positive side in the y-axis direction relative to the signal line 20, so as to be aligned in the x-axis direction. The via-hole conductors B2 pierce through the line portions 18b-a and 18b-b of the dielectric sheet 18b in the z-axis direction, and, when viewed in a plan view in the z-axis direction, the via-hole conductors B2 are positioned on the positive side in the y-axis direction relative to the signal line 20, so as to be aligned in the x-axis direction. The via-hole conductors B1 and B2 are connected to each other, such that each pair constitutes a single via-hole conductor. The end of the via-hole conductor B1 that is located on the positive side in the z-axis direction is connected to the ground conductor 22, and the end of the via-hole conductor B1 that is located on the negative side in the z-axis direction is connected to the ground conductor 26. Moreover, the end of the via-hole conductor B2 that is located on the positive side in the z-axis direction is connected to the ground conductor 26, and the end of the via-hole conductor B2 that is located on the negative side in the z-axis direction is connected to the ground conductor 24. As a result, the via-hole conductors B1 and B2 connect the ground conductors 22, 24, and 26.

The via-hole conductors B3 pierce through the line portions 18a-a and 18a-b of the dielectric sheet 18a in the z-axis direction, and, when viewed in a plan view in the z-axis direction, the via-hole conductors B3 are positioned on the negative side in the y-axis direction relative to the signal line 20, so as to be aligned in the x-axis direction. The via-hole conductors B4 pierce through the line portions 18b-a and 18b-b of the dielectric sheet 18b in the z-axis direction, and, when viewed in a plan view in the z-axis direction, the via-hole conductors B4 are positioned on the negative side in the y-axis direction relative to the signal line 20, so as to be aligned in the x-axis direction. The via-hole conductors B3 and B4 are connected to each other, such that each pair constitutes a single via-hole conductor. The end of the via-hole conductor B3 that is located on the positive side in the z-axis direction is connected to the ground conductor 22, and the end of the via-hole conductor B3 that is located on the negative side in the z-axis direction is connected to the ground conductor 26. Moreover, the end of the via-hole conductor B4 that is located on the positive side in the z-axis direction is connected to the ground conductor 26, and the end of the via-hole conductor B4 that is located on the negative side in the z-axis direction is connected to the ground conductor 24. As a result, the via-hole conductors B3 and B4 connect the ground conductors 22, 24, and 26.

The via-hole conductors B11 pierce through the line portions 18a-c and 18a-d of the dielectric sheet 18a in the z-axis direction, and, when viewed in a plan view in the z-axis direction, the via-hole conductors B11 are positioned on the positive side in the y-axis direction relative to the signal line 21, so as to be aligned in the x-axis direction. The via-hole conductors B12 pierce through the line portions 18b-c and 18b-d of the dielectric sheet 18b in the z-axis direction, and, when viewed in a plan view in the z-axis direction, the via-hole conductors B12 are positioned on the positive side in the y-axis direction relative to the signal line 21, so as to be aligned in the x-axis direction. The via-hole conductors B11 and B12 are connected to each other, such that each pair constitutes a single via-hole conductor. The end of the via-hole conductor B11 that is located on the positive side in the z-axis direction is connected to the ground conductor 22, and the end of the via-hole conductor B11 that is located on the negative side in the z-axis direction is connected to the ground conductor 26. Moreover, the end of the via-hole conductor B12 that is located on the positive side in the z-axis direction is connected to the ground conductor 26, and the end of the via-hole conductor B12 that is located on the negative side in the z-axis direction is connected to the ground conductor 24. As a result, the via-hole conductors B11 and B12 connect the ground conductors 22, 24, and 26. Note that in the sections where the line portions 12c and 12d extend in the y-axis direction, the via-hole conductors B11 and B12, when viewed in a plan view in the z-axis direction, are positioned on the negative side in the x-axis direction relative to the signal line 21, as shown in FIG. 4.

The via-hole conductors B13 pierce through the line portions 18a-c and 18a-d of the dielectric sheet 18a in the z-axis direction, and, when viewed in a plan view in the z-axis direction, the via-hole conductors B13 are positioned on the negative side in the y-axis direction relative to the signal line 21, so as to be aligned in the x-axis direction. The via-hole conductors B14 pierce through the line portions 18b-c and 18b-d of the dielectric sheet 18b in the z-axis direction, and, when viewed in a plan view in the z-axis direction, the via-hole conductors B14 are positioned on the negative side in the y-axis direction relative to the signal line 21, so as to be aligned in the x-axis direction. The via-hole conductors B13 and B14 are connected to each other, such that each pair constitutes a single via-hole conductor. The end of the via-hole conductor B13 that is located on the positive side in the z-axis direction is connected to the ground conductor 22, and the end of the via-hole conductor B13 that is located on the negative side in the z-axis direction is connected to the ground conductor 26. Moreover, the end of the via-hole conductor B14 that is located on the positive side in the z-axis direction is connected to the ground conductor 26, and the end of the via-hole conductor B14 that is located on the negative side in the z-axis direction is connected to the ground conductor 24. As a result, the via-hole conductors B13 and B14 connect the ground conductors 22, 24, and 26. Note that in the sections where the line portions 12c and 12d extend in the y-axis direction, the via-hole conductors B13 and B14, when viewed in a plan view in the z-axis direction, are positioned on the positive side in the x-axis direction relative to the signal line 21, as shown in FIG. 4.

The via-hole conductors b1 to b6, B1 to B4, and B11 to B14 are preferably made of a metal material mainly composed of silver or copper and having a low specific resistance, for example. Note that through-holes with conductor layers including inner circumferential surfaces formed by plating or other suitable process may be used in place of the via-hole conductors b1 to b6, B1 to B4, and B11 to B14.

The protective layer 14 covers the entire or substantially the entire top surface of the dielectric sheet 18a. Accordingly, the ground conductor 22 is covered by the protective layer 14. The protective layer 14 is made of, for example, a flexible resin such as a resist material.

Furthermore, as shown in FIGS. 2 through 6, the protective layer 14 includes line portions 14a to 14d, a crossing portion 14e, and connecting portions 14f to 14i. The line portions 14a to 14d and the crossing portion 14e cover the entire top surfaces of the line portions 18a-a, 18a-b, 18a-c, and 18a-d and the crossing portion 18a-e, respectively, thus covering the main conductors 22a to 22d.

The connecting portion 14g is connected to the end of the line portion 14b that is located on the positive side in the x-axis direction, so as to cover the top surface of the connecting portion 18a-g, as shown in FIG. 5. The connecting portion 14g has rectangular or substantially rectangular openings Ha to Hd provided therein. The opening Ha is a rectangular or substantially rectangular opening positioned at the center of the connecting portion 14g. The external terminal 16b is exposed to the outside from the opening Ha. The opening Hb is a rectangular or substantially rectangular opening positioned on the positive side in the y-axis direction relative to the opening Ha. The opening Hc is a rectangular or substantially rectangular opening positioned on the positive side in the x-axis direction relative to the opening Ha. The opening Hd is a rectangular or substantially rectangular opening positioned on the negative side in the y-axis direction relative to the opening Ha. The terminal conductor 22g is exposed to the outside from the openings Hb to Hd, so that the exposed portions serve as external terminals. Note that the connecting portion 14f has the same structure as the connecting portion 14g, and therefore is not shown in the figure, and further, any description thereof will be omitted.

The connecting portion 14i is connected to the end of the line portion 14d that is located on the positive side in the x-axis direction, so as to cover the top surface of the connecting portion 18a-i. The connecting portion 14i has rectangular or substantially rectangular openings He to Hh provided therein. The opening He is a rectangular opening positioned at the center of the connecting portion 14i. The external terminal 16d is exposed to the outside from the opening He. The opening Hf is a rectangular or substantially rectangular opening positioned on the positive side in the y-axis direction relative to the opening He. The opening Hg is a rectangular or substantially rectangular opening positioned on the positive side in the x-axis direction relative to the opening He. The opening Hh is a rectangular or substantially rectangular opening positioned on the negative side in the y-axis direction relative to the opening He. The terminal portion 22i is exposed to the outside from the openings Hf to Hh, so that the exposed portions serve as external terminals. Note that the connecting portion 14h has the same structure as the connecting portion 14i, and therefore is not shown in the figure, and further, any description thereof will be omitted.

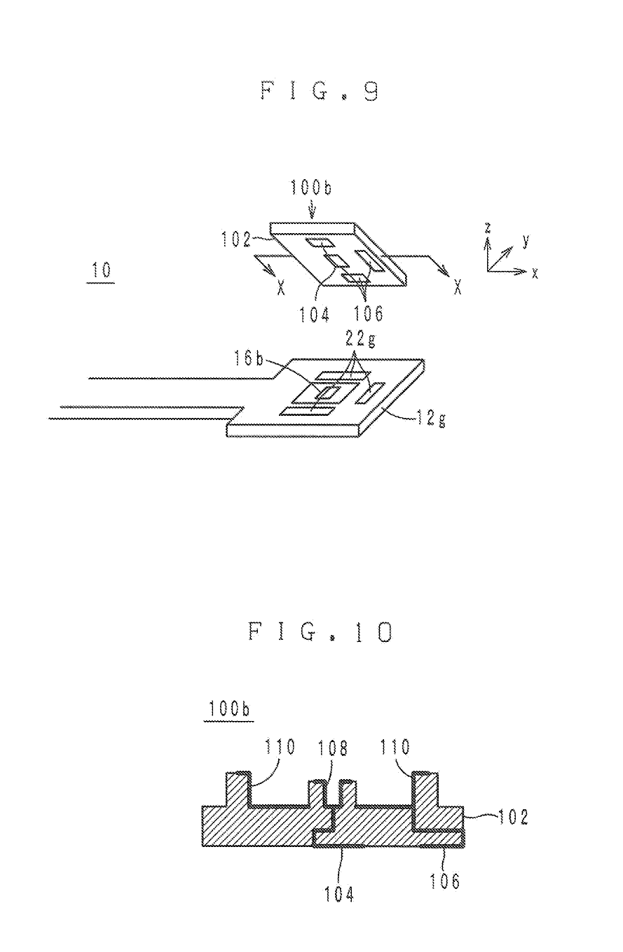

The connectors 100a and 100b are mounted on the top surfaces of the connecting portions 12f and 12g, respectively, and electrically connected to the signal line 20 and the ground conductors 22, 24, and 26. The connectors 100c and 100d are mounted on the top surfaces of the connecting portions 12h and 12i, respectively, and electrically connected to the signal line 21 and the ground conductors 22, 24, and 26. The connectors 100a to 100d are configured in the same manner, and therefore, only the configuration of the connector 100b will be described below by way of example. FIG. 9 is an external oblique view of the connector 100b in the high-frequency transmission line 10. FIG. 10 is a cross-sectional structure view of the connector 100b in the high-frequency transmission line 10.

The connector 100b includes a connector body 102, external terminals 104 and 106, a center conductor 108, and an external conductor 110, as shown in FIGS. 1, 9, and 10. The connector body 102 includes a rectangular or substantially rectangular plate and a cylindrical or substantially cylindrical portion coupled thereon, and is made of an insulating material such as resin.

The external terminal 104 is positioned on the plate of the connector body 102 on the negative side in the z-axis direction, so as to face the external terminal 16b. The external terminal 106 is positioned on the plate of the connector body 102 on the negative side in the z-axis direction, so as to correspond to the parts of the terminal conductor 22g that are exposed from the openings Hb to Hd.

The center conductor 108 is positioned at the center of the cylindrical or substantially cylindrical portion of the connector body 102, and is connected to the external terminal 104. The center conductor 108 is a signal terminal to/from which a high-frequency signal is inputted/outputted. The external conductor 110 is positioned on the inner circumferential surface of the cylindrical portion of the connector body 102, and is connected to the external terminal 106. The external conductor 110 is a ground terminal to be kept at a ground potential.

The connector 100b thus configured is mounted on the top surface of the connecting portion 12g, such that the external terminal 104 is connected to the external terminal 16b, and the external terminal 106 is connected to the terminal conductor 22g, as shown in FIGS. 9 and 10. As a result, the signal line 20 is electrically connected to the center conductor 108. In addition, the ground conductors 22, 24, and 26 are electrically connected to the external conductor 110.

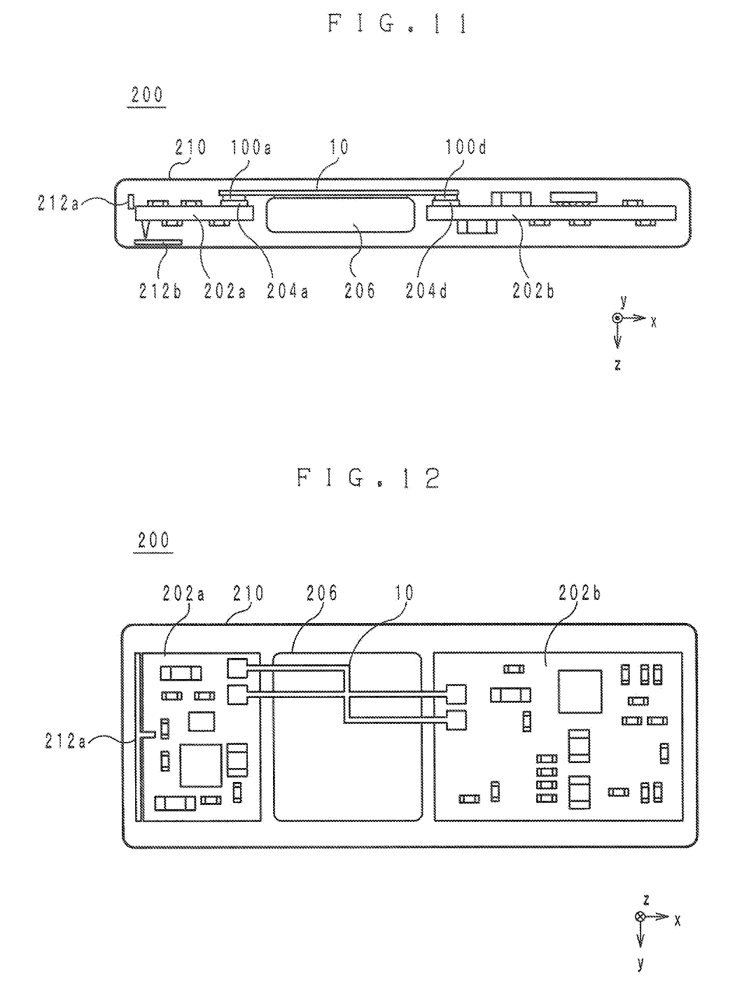

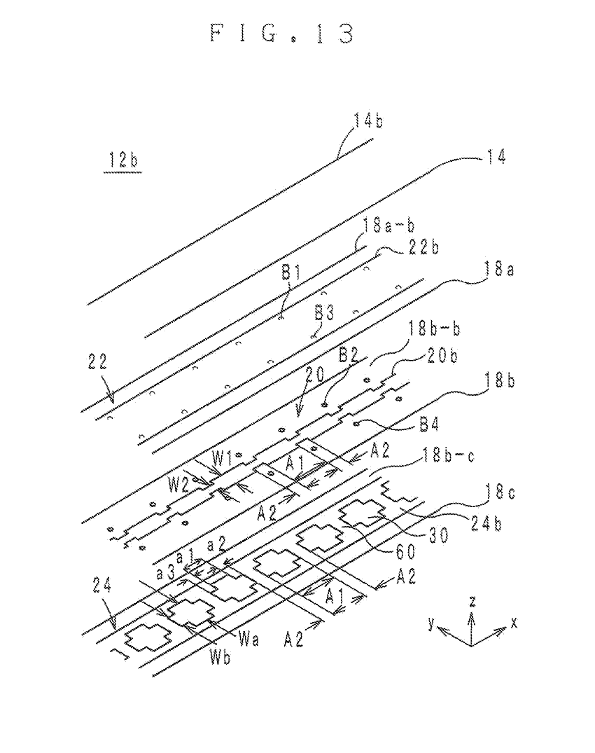

The high-frequency transmission line 10 preferably is used in a manner as will be described below. FIG. 11 illustrates an electronic device 200 provided with the high-frequency transmission line 10 as viewed in a plan view in the y-axis direction. FIG. 12 illustrates the electronic device 200 provided with the high-frequency transmission line 10 as viewed in a plan view in the z-axis direction.

The electronic device 200 includes the high-frequency transmission line 10, circuit boards 202a and 202b, receptacles 204a to 204d (the receptacles 204b and 204c are not shown in the figures), a battery pack (metallic body) 206, a housing 210, and antennas 212a and 212b.

The housing 210 accommodates the high-frequency transmission line 10, the circuit boards 202a and 202b, the receptacles 204a to 204d, the battery pack 206, and the antennas 212a and 212b, as shown in FIGS. 11 and 12. The circuit board 202a includes, for example, a transmission or reception circuit provided thereon. The circuit board 202b includes, for example, a power circuit (a radio frequency integrated circuit: RFIC) provided thereon. The battery pack 206 is, for example, a lithium-ion secondary battery, and the surface thereof is wrapped by a metal cover. The circuit board 202a, the battery pack 206, and the circuit board 202b are arranged in this order, from the negative side to the positive side in the x-axis direction.

The antenna 212a is connected to the circuit board 202a and is adapted to transmit/receive high-frequency signals in 800 MHz and 1800 MHz bands. The antenna 212b is connected to the circuit board 202a and is adapted to receive GPS signals.

The receptacle 204a is provided on the principal surface of the circuit board 202a on the negative side in the z-axis direction, and connected to the antenna 212a via a wiring trace provided on the circuit board 202a. The receptacle 204a is connected to the connector 100a. The receptacle 204b (not shown) is provided on the principal surface of the circuit board 202b on the negative side in the z-axis direction, and connected to the power circuit provided on the circuit board 202b. The receptacle 204b is connected to the connector 100b. Accordingly, high-frequency signals transmitted/received by the antenna 212a are transmitted to the signal line 20.

The receptacle 204c (not shown) is provided on the principal surface of the circuit board 202a on the negative side in the z-axis direction, and connected to the antenna 212b via a wiring trace provided on the circuit board 202a. The receptacle 204c is connected to the connector 100c. The receptacle 204d is provided on the principal surface of the circuit board 202b on the negative side in the z-axis direction, and connected to the power circuit provided on the circuit board 202b. The receptacle 204d is connected to the connector 100d. Accordingly, high-frequency signals, which are GPS signals, transmitted/received by the antenna 212b are transmitted to the signal line 21.

Here, the top surface of the dielectric element assembly 12 (more precisely, the protective layer 14) is in contact with the battery pack 206. The dielectric element assembly 12 and the battery pack 206 are fixed by an adhesive or suchlike.

A non-limiting example of a method for producing the high-frequency transmission line 10 will be described below with reference to FIGS. 1 through 6. While the following description focuses on one high-frequency transmission line 10 as a non-limiting example, in actuality, large-sized dielectric sheets preferably are laminated and cut, so that a plurality of high-frequency transmission lines 10 are produced at the same time.

Prepared first are dielectric sheets 18a to 18c made of a thermoplastic resin and having their entire top surfaces copper-foiled. The copper-foiled surfaces of the dielectric sheets 18a to 18c are smoothened, for example, by galvanization for rust prevention. The thickness of the copper foil preferably is about 10 μm to about 20 μm, for example.

Next, external terminals 16a to 16d, a line conductor 21e, and a ground conductor 22 are formed on the top surface of the dielectric sheet 18a by photolithography. Specifically, resists are printed on the copper foil on the top surface of the dielectric sheet 18a in the same shapes as the external terminals 16a to 16d, the line conductor 21e, and the ground conductor 22. Then, any portions of the copper foil that are not coated with the resists are removed by etching the copper foil. Thereafter, the resists are removed. In this manner, the external terminals 16a to 16d, the line conductor 21e, and the ground conductor 22 are formed on the top surface of the dielectric sheet 18a.

Next, line conductors 20a, 20b, 20f, 20g, 21c, 21d, 21h, and 21i and a ground conductor 26 are formed on the top surface of the dielectric sheet 18b by photolithography. In addition, a line conductor 20e and a ground conductor 24 are formed on the top surface of the dielectric sheet 18c by photolithography. The line conductors 20a, 20b, 20e, 20f, 20g, 21c, 21d, 21h, and 21i and the ground conductors 24 and 26 are formed in the same manner as the external terminals 16a to 16d, the line conductor 21e, and the ground conductor 22, and therefore, any descriptions about their formation steps will be omitted.

Next, via-holes are bored through the dielectric sheets 18a and 18b by irradiating their bottom surfaces with laser beams where via-hole conductors b1 to b6, B1 to B4, and B11 to B14 are to be formed. Thereafter, the via-holes provided in the dielectric sheets 18a and 18b are filled with a conductive paste.

Next, the dielectric sheets 18a to 18c are stacked in this order, from the positive side to the negative side in the z-axis direction. Then, the dielectric sheets 18a to 18c are heated and pressed from both the positive and negative sides in the z-axis direction, thus softening the dielectric sheets 18a to 18c so as to be bonded and integrated, while solidifying the conductive paste in the via-holes, so that the via-hole conductors b1 to b6, B1 to B4, and B11 to B14 are formed. Note that the via-hole conductors b1 to b6, B1 to B4, and B11 to B14 do not have to be obtained by filling via-holes completely with conductors, and may be obtained, for example, by forming conductors only along the inner circumferential surfaces of via-holes.

Next, a resin (resist) paste is applied to the top surface of the dielectric sheet 18a, thereby forming a protective layer 14.

Lastly, connectors 100a to 100d are mounted on connecting portions 12f to 12i, respectively, by soldering. By the foregoing process, a high-frequency transmission line 10 is completed.

The high-frequency transmission line 10 thus configured renders it possible to reduce the thickness of the dielectric element assembly 12 at crossing portions of the signal lines 20 and 21. More specifically, in the high-frequency transmission line 10, the portions of the signal line 20 that do not cross the signal line 21 (i.e., the line conductors 20a, 20b, 20f, and 20g) and the portions of the signal line 21 that do not cross the signal line 20 (i.e., the line conductors 21c, 21d, 21h, and 21i) are positioned on the same dielectric sheet 18b. Moreover, the portion of the signal line 20 that crosses the signal line 21 (i.e., the line conductor 20e) and the portion of the signal line 21 that crosses the signal line 20 (i.e., the line conductor 21e) are positioned on the dielectric sheets 18a and 18c, respectively. That is, in the high-frequency transmission line 10, only the portions of the signal lines 20 and 21 that cross each other are positioned on different dielectric sheets. This renders it possible to cross the signal lines 20 and 21 within one dielectric element assembly 12. Thus, it is possible to eliminate the need to place two dielectric element assemblies on each other, so that the dielectric element assembly 12 is significantly reduced in thickness at the crossing portions of the signal lines 20 and 21.

Furthermore, the high-frequency transmission line 10 renders it possible to significantly reduce or prevent crosstalk between the signal lines 20 and 21. More specifically, the high-frequency transmission line 10 includes the ground conductor 26 provided between the signal lines 20 and 21 in the z-axis direction so as to overlap with the crossing portions of the signal lines 20 and 21. The ground conductor 26 is kept at a ground potential. Accordingly, noise emitted from both of the signal lines 20 and 21 is absorbed into the ground conductor 26. As a result, crosstalk between the signal lines 20 and 21 is significantly reduced or prevented.

Furthermore, in the high-frequency transmission line 10, the line conductors 20a, 20b, 20f, 20g, 21c, and 21d are positioned on the same dielectric sheet 18b. In addition, in the high-frequency transmission line 10, the characteristic impedances of the line conductors 20a, 20b, 20f, 20g, 21c, and 21d are preferably set at a predetermined value (e.g., about 50Ω) because of the ground conductors 22, 24, and 26. On the other hand, the characteristic impedance of the line conductor 20e is preferably set at the predetermined value (e.g., about 50Ω) because of the ground conductors 22e and 26e, and the characteristic impedance of the line conductor 21e is preferably set at the predetermined value (e.g., about 50Ω) because of the ground conductors 24e and 26e. As a result, the characteristic impedance among all of the line conductors is preferably set at the predetermined value (e.g., about 50≠). Here, the line conductors 20e and 21e do not overlap with the ground conductors 22 and 24 in the z-axis direction. Accordingly, it is conceivable that the line conductors 20e and 21e might be coupled to metallic bodies, such as the battery pack 206, or grounds of external circuits. However, most of the electric-field energy (lines of electric force) of the line conductor 20e is coupled to the ground conductors 22e and 26e. Moreover, most of the electric-field energy (lines of electric force) of the line conductor 21e is coupled to the ground conductors 24e and 26e. Accordingly, the characteristic impedance does not change significantly even if the battery pack 206 and the signal line 20e are placed closer to each other. Thus, transmission loss is significantly reduced or prevented even if some portions of the high-frequency transmission line 10 are not covered by ground conductors.

### First Modification

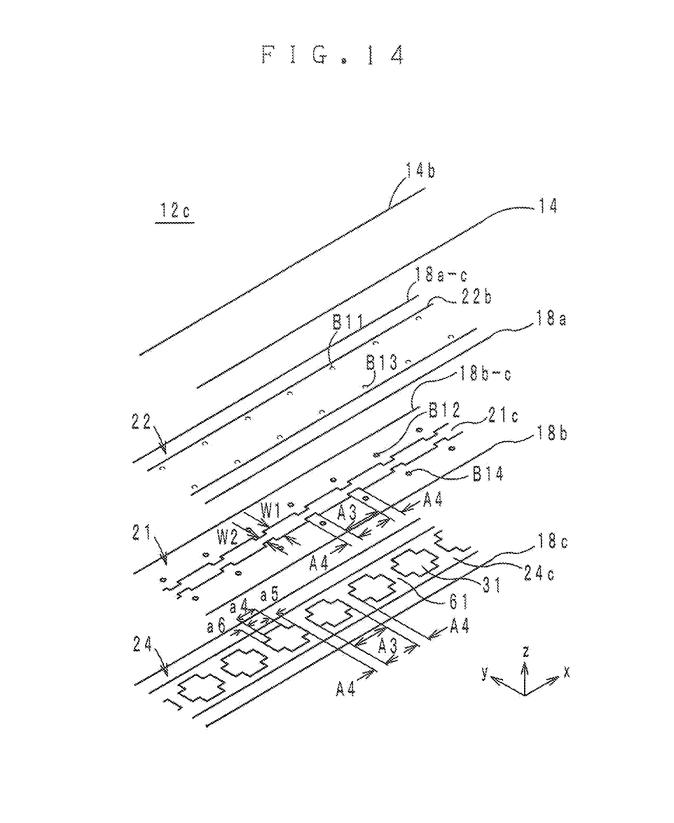

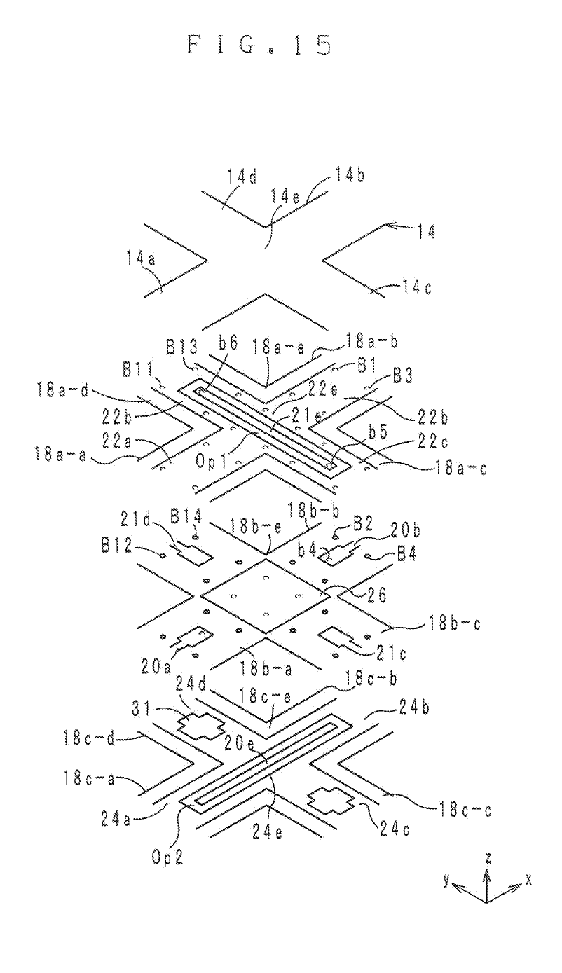

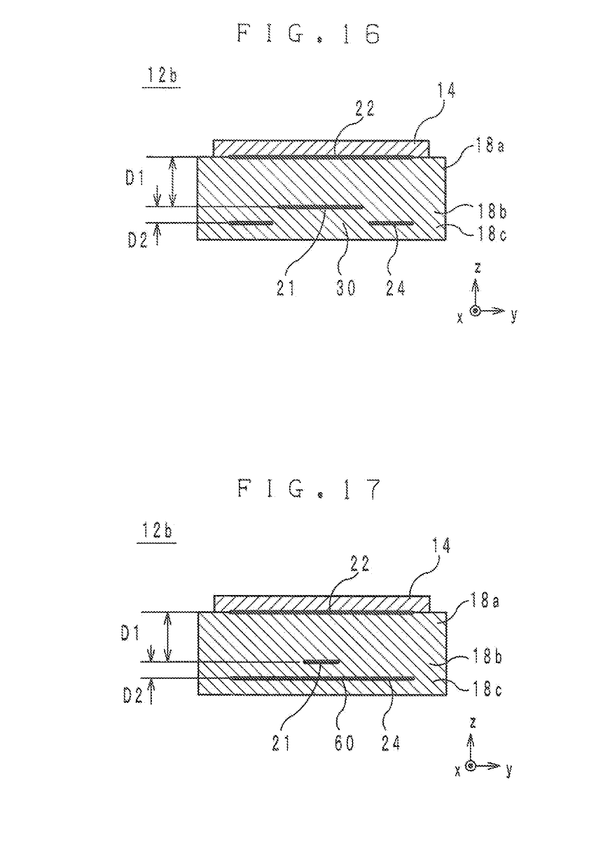

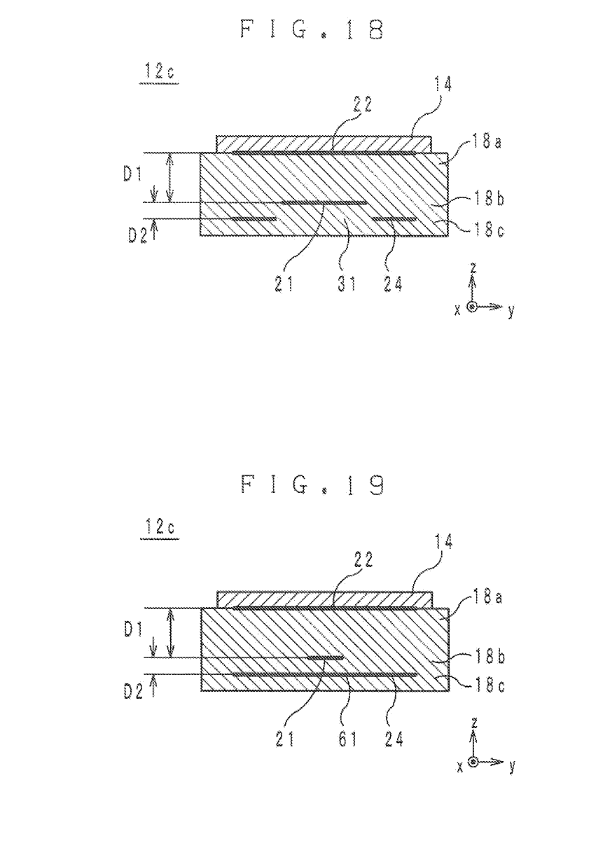

Hereinafter, a high-frequency transmission line 10a according to a first modification of a preferred embodiment of the present invention will be described with reference to the drawings. FIG. 13 is an exploded oblique view of a portion E1 of the high-frequency transmission line 10a according to the first modification. FIG. 14 is an exploded oblique view of a portion E2 of the high-frequency transmission line 10a according to the first modification. FIG. 15 is an exploded oblique view of a portion E3 of the high-frequency transmission line 10a according to the first modification. FIG. 16 is a cross-sectional structure view of a section A1 of the high-frequency transmission line 10a according to the first modification. FIG. 17 is a cross-sectional structure view of a section A2 of the high-frequency transmission line 10a according to the first modification. FIG. 18 is a cross-sectional structure view of a section A3 of the high-frequency transmission line 10a according to the first modification. FIG. 19 is a cross-sectional structure view of a section A4 of the high-frequency transmission line 10a according to the first modification. For an external oblique view of the high-frequency transmission line 10a, FIG. 1 will be referenced.

The high-frequency transmission line 10a differs from the high-frequency transmission line 10 in that openings 30 and 31 are provided in the ground conductor 24, the signal lines 20 and 21 do not have uniform widths, and the ground conductor 26 is provided only in the crossing portion 18b-e. The other features of the high-frequency transmission line 10a are the same as the high-frequency transmission line 10, and therefore, any descriptions thereof will be omitted.

The main conductors 24a and 24b of the ground conductor 24 include a plurality of openings 30 arranged along the signal line 20, as shown in FIGS. 13 and 15. The opening 30 is shaped such that the dimension in the y-axis direction is greater at the center in the x-axis direction than at either end in the x-axis direction, as shown in FIG. 13. In the following, a section of the opening 30 that is located at the center in the x-axis direction will be referred to as a “section a1”, a section located on the positive side in the x-axis direction relative to the section a1 will be referred to as a “section a2”, and a section located on the negative side in the x-axis direction relative to the section a1 will be referred to as a “section a3”. The dimension of the opening 30 in the y-axis direction is greater in the section a1 than both in the section a2 and in the section a3. Accordingly, the opening 30 is cross-shaped, in the shape of a rectangle whose four corners have been cut away in the shape of smaller rectangles.

The openings 30, when viewed in a plan view in the z-axis direction, overlap with the signal line 20. Portions of the ground conductor 24 that are positioned between adjacent openings 30 will be referred to as “bridge portions 60”. In this manner, the openings 30 and the bridge portions 60 are arranged so as to alternate with each other along the signal line 20. Accordingly, the signal line 20 overlaps alternatingly with the openings 30 and the bridge portions 60. The interval between adjacent bridge portions 60 is shorter than half the wavelength of a high-frequency signal to be transmitted through the signal line 20.

Furthermore, in the high-frequency transmission line 10a, a section where the signal line 20 overlaps with the opening 30 will be referred to as a “section A1”, and a section where the signal line 20 overlaps with the bridge portion 60 will be referred to as a “section A2”. The width W1 of the signal line 20 in the section A1 is greater than the width W2 of the signal line 20 in the section A2, as shown in FIG. 13. More specifically, the width W1 of the signal line 20 at the overlap with the opening 30 is greater than the width W2 of the signal line 20 at the overlap with the bridge portion 60.

As described above, no openings are provided in the main conductors 22a and 22b, and the openings 30 are provided in the main conductors 24a and 24b, so that the overlap of the ground conductor 24 with the signal line 20 is smaller in area than the overlap of the ground conductor 22 with the signal line 20.

Furthermore, the main conductors 24c and 24d of the ground conductor 24 include a plurality of openings 31 arranged along the signal line 21, as shown in FIGS. 14 and 15. The opening 31 is shaped such that the dimension in the y-axis direction is greater at the center in the x-axis direction than at either end in the x-axis direction, as shown in FIG. 14. In the following, a section of the opening 31 that is located at the center in the x-axis direction will be referred to as a “section a4”, a section located on the positive side in the x-axis direction relative to the section a4 will be referred to as a “section a5”, and a section located on the negative side in the x-axis direction relative to the section a4 will be referred to as a “section a6”. The dimension of the opening 31 in the y-axis direction is greater in the section a4 than both in the section a5 and in the section a6. Accordingly, the opening 31 is cross-shaped, in the shape of a rectangle whose four corners have been cut away in the shape of smaller rectangles.

The openings 31, when viewed in a plan view in the z-axis direction, overlap with the signal line 21. Portions of the ground conductor 24 that are positioned between adjacent openings 31 will be referred to as “bridge portions 61”. In this manner, the openings 31 and the bridge portions 61 are arranged so as to alternate with each other along the signal line 21. Accordingly, the signal line 21 overlaps alternatingly with the openings 31 and the bridge portions 61. The interval between adjacent bridge portions 61 is shorter than half the wavelength of a high-frequency signal to be transmitted through the signal line 21.

Furthermore, in the high-frequency transmission line 10a, a section where the signal line 21 overlaps with the opening 31 will be referred to as a “section A3”, and a section where the signal line 21 overlaps with the bridge portion 61 will be referred to as a “section A4”. The width W1 of the signal line 21 in the section A3 is greater than the width W2 of the signal line 21 in the section A4, as shown in FIG. 14. More specifically, the width W1 of the signal line 21 at the overlap with the opening 31 is greater than the width W2 of the signal line 21 at the overlap with the bridge portion 61.

As described above, no openings are provided in the main conductors 22c and 22d, and the openings 31 are provided in the main conductors 24c and 24d, so that the overlap of the ground conductor 24 with the signal line 21 is smaller in area than the overlap of the ground conductor 22 with the signal line 21.

In this manner, the characteristic impedances of the signal lines 20 and 21 in the high-frequency transmission line 10a are mainly determined by the opposed areas of the signal lines 20 and 21 and the ground conductor 22 and the distances therebetween, as well as by the relative permittivities of the dielectric sheets 18a to 18c. Therefore, in the case where the characteristic impedance of each of the signal lines 20 and 21 is preferably set to about 50Ω, for example, the characteristic impedance of each of the signal lines 20 and 21 preferably is designed to become about 55Ω, slightly higher than about 50Ω, for example, because of the influence of the signal lines 20 and 21 and the ground conductor 22. Moreover, the ground conductor 24 is shaped such that the characteristic impedance of each of the signal lines 20 and 21 becomes about 50Ω because of the influence of the signal lines 20 and 21 and the ground conductors 22 and 24. In this manner, the ground conductor 22 plays the role of a reference ground conductor for the signal lines 20 and 21.

On the other hand, the ground conductor 24 is a ground conductor that doubles as a shield for the signal lines 20 and 21. Moreover, the ground conductor 24 is designed to make final adjustments such that the characteristic impedance of each of the signal lines 20 and 21 is preferably set to about 50Ω, as described above. More specifically, the sizes of the openings 30 and 31, the widths of the bridge portions 60 and 61, etc., are designed. In this manner, the ground conductor 24 plays the role of an auxiliary ground conductor for the signal lines 20 and 21.

Furthermore, the distance D1 between each of the signal lines 20 and 21 and the ground conductor 22 in the z-axis direction is greater than the distance D2 between each of the signal lines 20 and 21 and the ground conductor 24 in the z-axis direction, as shown in FIGS. 16 through 19. The distance D1 is equal or approximately equal to the thickness of the dielectric sheet 18a, and the distance D2 is equal or approximately equal to the thickness of the dielectric sheet 18b.

In the high-frequency transmission line 10a thus configured, the characteristic impedance of the signal line 20 repeatedly fluctuates between two adjacent bridge portions 60 in such a manner as to increase in the order: minimum value Z3, intermediate value Z2, and maximum value Z1 and thereafter, decrease in the order: maximum value Z1, intermediate value Z2, and minimum value Z3. More specifically, large capacitance is created between the signal line 20 and the ground conductor 24 in the section A2 where the signal line 20 overlaps with the bridge portion 60. Accordingly, in the section A2, capacitance (C) property is dominant in the characteristic impedance of the signal line 20. Therefore, in the section A2, the characteristic impedance of the signal line 20 is at the minimum value Z3.

Furthermore, in the signal line 20, the dimension of the opening 30 in the y-axis direction is at the maximum value in the section a1. As a result, small capacitance is created between the signal line 20 and the ground conductor 24 in the section a1. Accordingly, in the section a1, inductance (L) property is dominant in the characteristic impedance of the signal line 20. Therefore, in the section a1, the characteristic impedance of the signal line 20 is at the maximum value Z1.

Furthermore, in the signal line 20, the dimension of the opening 30 in the y-axis direction is less than the maximum value both in the section a2 and in the section a3. As a result, in the sections a2 and a3, medium capacitance is created between the signal line 20 and the ground conductor 24. Accordingly, in the sections a2 and a3, both inductance (L) and capacitance (C) properties are dominant in the characteristic impedance of the signal line 20. Therefore, in the sections a2 and a3, the characteristic impedance of the signal line 20 is at the intermediate value Z2.

Here, the sections between adjacent bridge portions 60 are arranged in the order: A2, a3, a1, a2, and A2, from the negative side to the positive side in the x-axis direction. Accordingly, the characteristic impedance of the signal line 20 fluctuates between adjacent bridge portions 60 in the order: minimum value Z3, intermediate value Z2, maximum value Z1, intermediate value Z2, and minimum value Z3. Moreover, the bridge portions 60 and the openings 30 alternatingly overlap along the signal line 20. Therefore, the characteristic impedance of the signal line 20 increases and decreases cyclically. Note that the maximum value Z1 preferably is, for example, about 70Ω, the intermediate value Z2 preferably is, for example, about 55Ω, and the minimum value Z3 preferably is, for example, about 30Ω. Further, the high-frequency transmission line 10a preferably is designed such that the average characteristic impedance of the entire signal line 20 is about 50Ω, for example. Note that the characteristic impedance of the signal line 21 fluctuates in the same manner as the characteristic impedance of the signal line 20.

As with the high-frequency transmission line 10, the high-frequency transmission line 10a thus configured is significantly reduced in thickness of the dielectric element assembly 12 at the crossing portions of the signal lines 20 and 21.

Further, as with the high-frequency transmission line 10, the high-frequency transmission line 10a renders it possible to significantly reduce or prevent crosstalk between the signal lines 20 and 21.

Furthermore, the high-frequency transmission line 10a is significantly thinner. More specifically, in the high-frequency transmission line 10a, the signal line 20, when viewed in a plan view in the z-axis direction, does not overlap with the ground conductor 24 in the section A1. Accordingly, little capacitance is created between the signal line 20 and the ground conductor 24. Therefore, even if the distance between the signal line 20 and the ground conductor 24 in the z-axis direction is reduced, the capacitance created between the signal line 20 and the ground conductor 24 does not become excessively large. As a result, the characteristic impedance of the signal line 20 becomes less likely to deviate from a predetermined value (e.g., about 50Ω). Thus, it is possible to make the high-frequency transmission line 10a thinner while keeping the characteristic impedance of the signal line 20 at the predetermined value. Note that for the same reason, it is possible to make the high-frequency transmission line 10a thinner while keeping the characteristic impedance of the signal line 21 at the predetermined value. Reducing the thickness of the high-frequency transmission line 10a allows the high-frequency transmission line 10a to be bent more readily.

Furthermore, in the high-frequency transmission line 10a, transmission loss in the signal line 20 is significantly reduced or prevented. More specifically, in the section A1, the signal line 20 overlaps with the opening 30, so that little capacitance is created between the signal line 20 and the ground conductor 24. Therefore, even if the width W1 of the signal line 20 in the section A1 is set greater than the width W2 of the signal line 20 in the section A2, the characteristic impedance of the signal line 20 does not become excessively lower in the section A1 than in the section A2. As a result, the high-frequency transmission line 10a renders it possible to reduce the resistance of the signal line 20 while keeping the characteristic impedance of the signal line 20 at a predetermined value. Thus, the high-frequency transmission line 10a renders it possible to reduce transmission loss in the signal line 20. Note that for the same reason, transmission loss in the signal line 21 is significantly reduced or prevented as well.

Furthermore, the high-frequency transmission line 10a renders it possible to significantly reduce or prevent the adverse effect of spurious radiation from the signal line 20. More specifically, in the high-frequency transmission line 10a, the openings 30 are arranged along the signal line 20. Accordingly, the characteristic impedance of the signal line 20 is higher in the section A1 where the signal line 20 overlaps with the opening 30 than in the section A2 where the signal line 20 overlaps with the bridge portion 60. Since the openings 30 and the bridge portions 60 alternatingly overlap with the signal line 20, the characteristic impedance of the signal line 20 fluctuates cyclically. In such a case, a standing wave occurs between two adjacent sections A1, resulting in spurious radiation. Therefore, by setting the interval between adjacent openings 30 less than or equal to half the wavelength of a high-frequency signal to be used by the electronic device 200, it is rendered possible to keep the frequency of spurious radiation from the signal line 20 outside the frequency band for high-frequency signals to be used by the electronic device 200. Thus, the adverse effect of spurious radiation from the signal line 20 on the electronic device 200 is significantly reduced or prevented. Note that for the same reason, the adverse effect of spurious radiation from the signal line 21 on the electronic device 200 is significantly reduced or prevented as well.

Furthermore, in the high-frequency transmission line 10a, the dimension of the opening 30 in the y-axis direction is greater in the section a1 than both in the section a2 and in the section a3. Accordingly, the distance between the signal line 20 and the ground conductor 24 is greater in the section a1 than in the sections a2 and a3. Moreover, the signal line 20 and the bridge portion 60 overlap with each other in the section A2. Accordingly, the distance between the signal line 20 and the ground conductor 24 is greater in the sections a2 and a3 than in the section A2. Therefore, in the section between adjacent bridge portions 60, the distance between the signal line 20 and the ground conductor 24 increases gradually, and thereafter, decreases gradually, through the course from the negative side to the positive side in the x-axis direction.

Here, a magnetic field becomes more likely to be generated around the signal line 20 as the distance between the signal line 20 and the ground conductor 24 increases. Accordingly, in the section between adjacent bridge portions 60, the magnetic field generated by the signal line 20 increases gradually, and thereafter, decreases gradually, through the course from the negative side to the positive side in the x-axis direction. As a result, the intensity of the magnetic field is prevented from changing sharply at the boundaries of the sections a1 to a3 and A2. Therefore, reflection of a high-frequency signal at the boundaries of the sections a1 to a3 and A2 is significantly reduced, so that occurrence of a standing wave in the signal line 20 is prevented. Thus, in the high-frequency transmission line 10a, spurious radiation from the signal line 20 is significantly reduced or prevented. Note that for the same reason, spurious radiation from the signal line 21 is significantly reduced or prevented as well.

Furthermore, in the high-frequency transmission line 10a, the openings 30 are provided in the ground conductor 24, so that the characteristic impedance of the signal line 20 fluctuates cyclically. Therefore, when the high-frequency transmission line 10a is bent, the characteristic impedance of the signal line changes to a smaller degree compared to a high-frequency transmission line in which the characteristic impedance of a signal line is constant. Here, the high-frequency transmission line in which the characteristic impedance of a signal line is constant is intended to mean a high-frequency transmission line including, for example, either a solid ground conductor or aground conductor with a slit-shaped opening.

Furthermore, in the high-frequency transmission line 10a, the openings 31 are provided in the ground conductor 22, so that the characteristic impedance of the signal line 21 fluctuates cyclically. Therefore, when the high-frequency transmission line 10a is bent, the characteristic impedance of the signal line changes to a smaller degree compared to a high-frequency transmission line in which the characteristic impedance of a signal line is constant.

Furthermore, the high-frequency transmission line 10a renders it possible to prevent the characteristic impedance of each of the signal lines 20 and 21 from changing from a predetermined value. More specifically, the top surface of the dielectric element assembly 12 (more precisely, the protective layer 14) is in contact with the battery pack 206. In addition, the dielectric element assembly 12 and the battery pack 206 are fixed by an adhesive or other suitable material. Therefore, the ground conductor 22 in a solid form free of openings is positioned between the signal lines 20 and 21 and the battery pack 206. As a result, capacitance is prevented from being created between each of the signal lines 20 and 21 and the battery pack 206. Thus, the characteristic impedance of each of the signal lines 20 and 21 is prevented from changing from the predetermined value.

### Second Modification

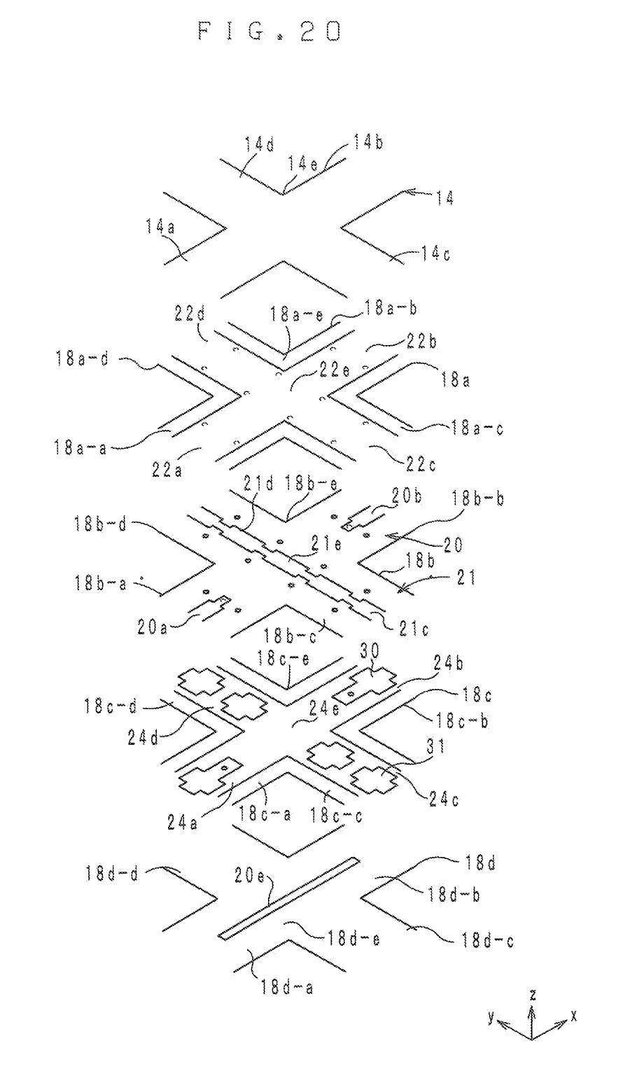

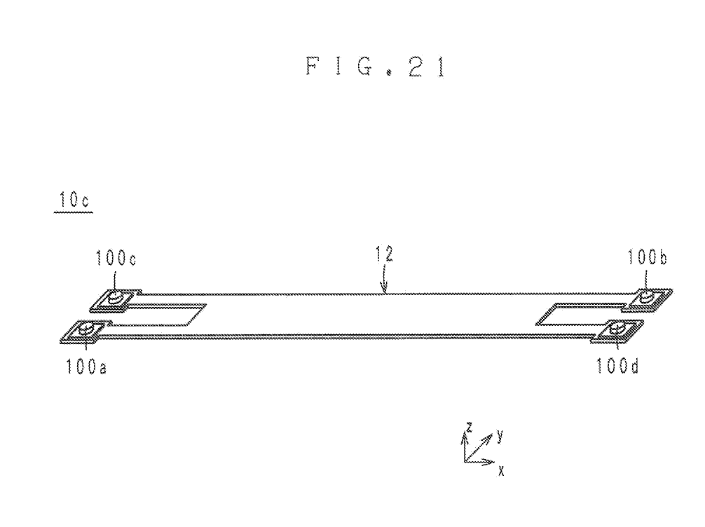

Hereinafter, a high-frequency transmission line 10b according to a second modification of a preferred embodiment of the present invention will be described with reference to the drawings. FIG. 20 is an exploded oblique view of a portion E3 of the high-frequency transmission line 10b according to the second modification. For an external oblique view of the high-frequency transmission line 10b, FIG. 1 will be referenced.

The high-frequency transmission line 10b differs from the high-frequency transmission line 10a in the following aspects. The first difference is that the high-frequency transmission line 10b does not include the ground conductor 26. The second difference is that the signal line 21 is positioned in its entirety on the dielectric sheet 18b. The third difference is that a dielectric sheet 18e is additionally provided, so that the line conductor 20e is positioned on the top surface of the dielectric sheet 18e. The fourth difference is that the ground conductor 24 is positioned between the line conductors 20a, 20b, 20f, 20g, 21c to 21e, 21h, and 21i and the line conductor 20e in the z-axis direction.

In the high-frequency transmission line 10b, the line conductors 20a, 20b, 20f, 20g, 21c to 21e, 21h, and 21i are positioned on the top surface of the dielectric sheet 18b between the ground conductors 22 and 24 in the z-axis direction, as shown in FIG. 20. Moreover, the line conductor 20e is positioned on the top surface of the dielectric sheet 18e. Accordingly, the portion of the signal line 20 that crosses the signal line 21 (i.e., the line conductor 20e) is positioned on the negative side in the z-axis direction relative to the ground conductor 24. Therefore, in the high-frequency transmission line 10b, the crossing conductor 24e is a portion of the ground conductor 24 that overlaps with the crossing portions of the signal lines 20 and 21.

In the high-frequency transmission line 10b thus configured, the crossing conductor 24e, which is kept at a ground potential, is positioned between the line conductors 20e and 21e. That is, the crossing conductor 24e functions as an intermediate ground conductor. Thus, as with the high-frequency transmission line 10, the high-frequency transmission line 10b renders it possible to significantly reduce or prevent crosstalk between the signal lines 20 and 21.

Furthermore, in the high-frequency transmission line 10b, the signal line 21 is positioned in its entirety on the top surface of the dielectric sheet 18b, and therefore, does not extend to any dielectric sheet other than the dielectric sheet 18b through via-hole conductors or suchlike. Accordingly, the characteristic impedance of the signal line 21 is more resistant to fluctuations. Therefore, the signal line 20 can be used as a signal line with a wider range of allowable fluctuations in characteristic impedance, and the signal line 21 can be used as a signal line with a narrower range of allowable fluctuations in characteristic impedance. Thus, the high-frequency transmission line 10b can be configured in accordance with the characteristics required of signal lines.

Furthermore, the high-frequency transmission line 10b includes the two ground conductors 22 and 24 but no ground conductor 26. Thus, the high-frequency transmission line 10b renders it possible to reduce the number of ground conductors.

Note that in the high-frequency transmission line 10b, the line conductor 20e of the signal line 20 is positioned on the negative side in the z-axis direction relative to the signal line 21e and the intermediate ground conductor (i.e., the crossing conductor 24e), but the line conductor 20e can be positioned on the positive side in the z-axis direction relative to the signal line 21e. In such a case, a crossing conductor to serve as an intermediate ground conductor is provided so as to be positioned on the positive side in the z-axis direction relative to the signal line 21e and also on the negative side in the z-axis direction relative to the signal line 20e.

### Third Modification

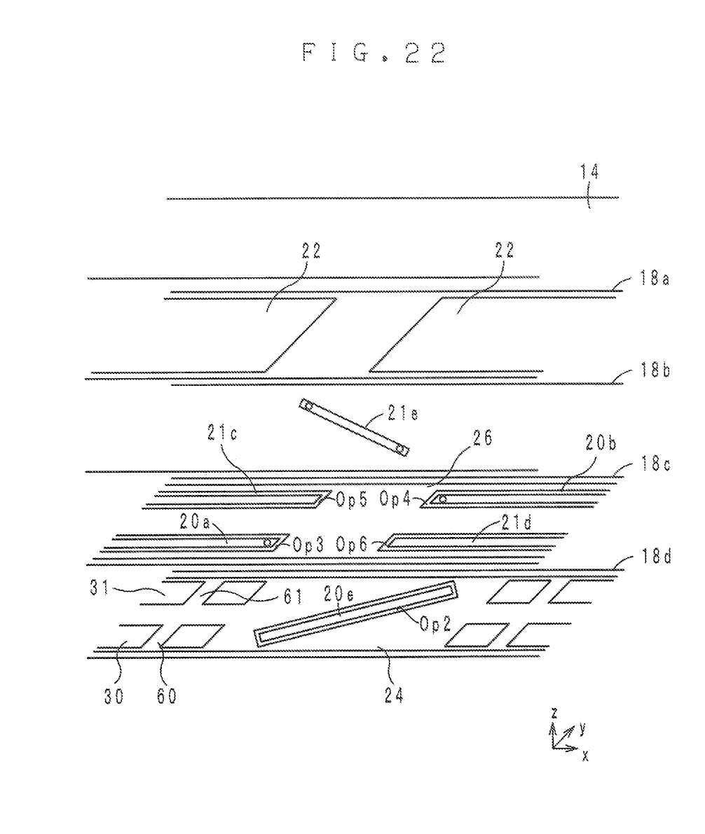

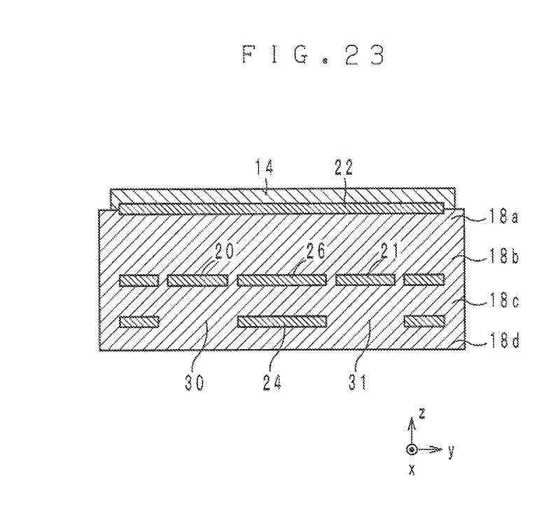

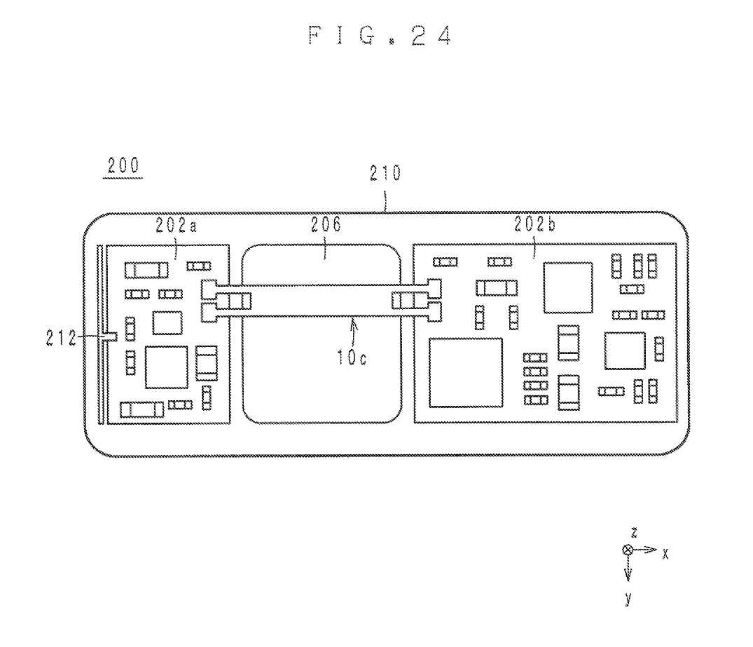

Hereinafter, a high-frequency transmission line 10c according to a third modification of a preferred embodiment of the present invention will be described with reference to the drawings. FIG. 21 is an external oblique view of the high-frequency transmission line 10c according to the third modification. FIG. 22 is an exploded oblique view of the high-frequency transmission line 10c according to the third modification. FIG. 23 is a cross-sectional structure view of the high-frequency transmission line 10c according to the third modification.

The high-frequency transmission line 10c differs from the high-frequency transmission line 10a in that the signal lines 20 and 21 are at least partially parallel or substantially parallel to each other.

The dielectric element assembly 12 extends in the x-axis direction and is divided into two branches at the end on each of the positive and negative sides in the x-axis direction, as shown in FIG. 21. The dielectric element assembly 12 is a flexible laminate preferably formed by laminating the protective layer 14 and the dielectric sheets 18a to 18d in this order from the positive side to the negative side in the z-axis direction, as shown in FIG. 22. In the following, the principal surface of the dielectric element assembly 12 that is located on the positive side in the z-axis direction will be referred to as a top surface, and the principal surface of the dielectric element assembly 12 that is located on the negative side in the z-axis direction will be referred to as a bottom surface.

The dielectric sheets 18a to 18d, when viewed in a plan view in the z-axis direction, have the same shape as the dielectric element assembly 12. The dielectric sheets 18a to 18d preferably are made of a flexible thermoplastic resin such as liquid crystal polymer or polyimide. Each of the dielectric sheets 18a to 18d preferably has a thickness of, for example, about 25 μm to about 200 μm after lamination. In the following, the principal surface of each of the dielectric sheets 18a to 18d that is located on the positive side in the z-axis direction will be referred to as atop surface, and the principal surface of each of the dielectric sheets 18a to 18d that is located on the negative side in the z-axis direction will be referred to as a bottom surface.

The signal line 20 is provided in the dielectric element assembly 12, and includes line conductors 20a, 20b, and 20e, as shown in FIGS. 22 and 23. The line conductors 20a and 20b are linear conductors positioned on the top surface of the dielectric sheet 18c, so as to extend in the x-axis direction. The line conductor 20a is positioned on the negative side in the x-axis direction relative to the line conductor 20b and also on the negative side in the y-axis direction relative to the line conductor 20b.

The line conductor 20e is a linear conductor positioned on the top surface of the dielectric sheet 18d, and is inclined with respect to the x-axis toward the positive side in the x-axis direction so as to point toward the positive side in the y-axis direction. The end of the line conductor 20a that is located on the positive side in the x-axis direction overlaps with the end of the line conductor 20e that is located on the negative side in the x-axis direction. In addition, the end of the line conductor 20a that is located on the positive side in the x-axis direction is connected to the end of the line conductor 20e that is located on the negative side in the x-axis direction by a via-hole conductor. The end of the line conductor 20b that is located on the negative side in the x-axis direction overlaps with the end of the line conductor 20e that is located on the positive side in the x-axis direction. In addition, the end of the line conductor 20b that is located on the negative side in the x-axis direction is connected to the end of the line conductor 20e that is located on the positive side in the x-axis direction by a via-hole conductor. The signal line 20 preferably is made of a metal material mainly composed of silver or copper and having a low specific resistance, for example.

The signal line 21 is provided in the dielectric element assembly 12, and includes line conductors 21c, 21d, and 21e, as shown in FIGS. 22 and 23. The line conductors 21c and 21d are linear conductors positioned on the top surface of the dielectric sheet 18c, so as to extend in the x-axis direction. The line conductor 21c is positioned on the negative side in the x-axis direction relative to the line conductor 21d and also on the positive side in the y-axis direction relative to the line conductor 21d. Accordingly, the line conductors 20a and 21c are parallel or substantially parallel to each other. In addition, the line conductors 20b and 21d are parallel to each other.

The line conductor 21e is a linear conductor positioned on the top surface of the dielectric sheet 18b, and is inclined with respect to the x-axis toward the positive side in the x-axis direction so as to point toward the negative side in the y-axis direction. The end of the line conductor 21c that is located on the positive side in the x-axis direction overlaps with the end of the line conductor 21e that is located on the negative side in the x-axis direction. In addition, the end of the line conductor 21c that is located on the positive side in the x-axis direction is connected to the end of the line conductor 21e that is located on the negative side in the x-axis direction by a via-hole conductor. The end of the line conductor 21d that is located on the negative side in the x-axis direction overlaps with the end of the line conductor 21e that is located on the positive side in the x-axis direction. In addition, the end of the line conductor 21d that is located on the negative side in the x-axis direction is connected to the end of the line conductor 21e that is located on the positive side in the x-axis direction by a via-hole conductor. Moreover, the line conductors 20e of the signal line 20 and the line conductor 21e of the signal line 21 cross each other when viewed in a plan view in the z-axis direction. The signal line 21 preferably is made of a metal material mainly composed of silver or copper and having a low specific resistance, for example.

The ground conductor 22 is provided in the dielectric element assembly 12 so as to be positioned on the positive side in the z-axis direction relative to the line conductors 20a, 20b, 21c, and 21d, as shown in FIGS. 22 and 23, and more specifically, the ground conductor 22 is positioned on the top surface of the dielectric sheet 18a. The ground conductor 22, when viewed in a plan view in the z-axis direction, has the same or approximately the same shape as the dielectric element assembly 12, and overlaps with the signal lines 20 and 21. More specifically, the ground conductor 22 overlaps with the signal line 21 at opposite ends of the line conductor 21e but not at other portions. The ground conductor 22 preferably is made of a metal material mainly composed of silver or copper and having a low specific resistance, for example.

The ground conductor 24 is provided in the dielectric element assembly 12 so as to be positioned on the negative side in the z-axis direction relative to the line conductors 20a, 20b, 21c, and 21d, as shown in FIGS. 21 and 22, and more specifically, the ground conductor 24 is positioned on the top surface of the dielectric sheet 18d. The ground conductor 24, when viewed in a plan view in the z-axis direction, has the same or approximately the same shape as the dielectric element assembly 12, and overlaps with the signal lines 20 and 21. More specifically, the ground conductor 24 has an opening Op2 provided therein. The line conductor 20e is positioned within the opening Op2. Accordingly, the ground conductor 24 does not overlap with the line conductor 20e. The ground conductor 24 preferably is made of a metal material mainly composed of silver or copper and having a low specific resistance, for example.

Here, the ground conductor 24 preferably includes a plurality of rectangular or substantially rectangular openings 30 and a plurality of rectangular or substantially rectangular openings 31 provided therein, as shown in FIG. 22. The openings 30, when viewed in a plan view in the z-axis direction, overlap with the signal line 20, and are arranged along the signal line 20. The openings 31, when viewed in a plan view in the z-axis direction, overlap with the signal line 21, and are arranged along the signal line 21.

The ground conductor 26 is provided in the dielectric element assembly 12 so as to be positioned on the same surface of the dielectric sheet 18c on which the line conductors 20a, 20b, 21c, and 21d are positioned, as shown in FIGS. 21 and 22. The ground conductor 26, when viewed in a plan view in the z-axis direction, has the same or approximately the same shape as the dielectric element assembly 12. More specifically, the ground conductor 26 includes openings Op3 to Op6 provided therein. In addition, the line conductors 20a, 20b, 21c, and 21d are positioned within the openings Op3 to Op6, respectively. Accordingly, the ground conductor 26 does not overlap with the line conductors 20a, 20b, 21c, and 21d. The ground conductor 26, when viewed in a plan view in the z-axis direction, is positioned between the line conductors 20e and 21e in the z-axis direction, so as to overlap with the signal conductors 20e and 21e. The ground conductor 26 preferably is made of a metal material mainly composed of silver or copper and having a low specific resistance, for example.

The protective layer 14 covers approximately the entire top surface of the dielectric sheet 18a. Accordingly, the ground conductor 22 is covered by the protective layer 14. The protective layer 14 is made of, for example, a flexible resin such as a resist material.

The other features of the high-frequency transmission line 10c are the same as the high-frequency transmission line 10a, and therefore, any descriptions thereof will be omitted.

The high-frequency transmission line 10c is preferably used in a manner as will be described below. FIG. 24 illustrates an electronic device 200 provided with the high-frequency transmission line 10c as viewed in a plan view in the z-axis direction.

The electronic device 200 includes the high-frequency transmission line 10c, circuit boards 202a and 202b, a battery pack (metallic body) 206, a housing 210, and an antenna 212.

The housing 210 accommodates the high-frequency transmission line 10c, the circuit boards 202a and 202b, the battery pack 206, and the antenna 212, as shown in FIG. 24. The circuit board 202a includes, for example, a transmission or reception circuit provided thereon. The circuit board 202b includes, for example, a power circuit (a radio frequency integrated circuit: RFIC) provided thereon. The battery pack 206 is, for example, a lithium-ion secondary battery, and the surface thereof is wrapped by a metal cover. The circuit board 202a, the battery pack 206, and the circuit board 202b are arranged in this order, from the negative side to the positive side in the x-axis direction. Moreover, the antenna 212 is connected to the circuit board 202a.

The high-frequency transmission line 10c connects the circuit boards 202a and 202b. Moreover, the top surface of the dielectric element assembly 12 (more precisely, the protective layer 14) is in contact with the battery pack 206. The battery pack 206 is fixed on the top surface of the dielectric element assembly 12 by an adhesive or suchlike.

The high-frequency transmission line 10c thus configured has the ground conductor 26 provided between the line conductors 20e and 21e. Therefore, as with the high-frequency transmission line 10a, the high-frequency transmission line 10c renders it possible to significantly reduce or prevent crosstalk between the signal lines 20 and 21.

Further, the ground conductor 26 is positioned at least partially between the line conductors 20a and 21c and also between the line conductors 20b and 21d. Thus, crosstalk between the signal lines 20 and 21 is further significantly reduced or prevented.

### Other Preferred Embodiments

The present invention is not limited to the high-frequency transmission lines 10 and 10a to 10c according to the above preferred embodiments, and variations can be made within the spirit and scope of the present invention.

Further, the configuration of the high-frequency transmission lines 10 and 10a to 10c may be used in combination, for example.

Note that the electronic device 200 is not limited to mobile communication terminals, such as cell phones, tablet computers, and notebook computers, and encompasses any device including a signal line for high-frequency signal transmission, such as digital cameras and desktop computers.

Further, the high-frequency transmission lines 10 and 10a to 10c may be used to connect matching circuits for high-frequency signals, rather than to connect antennas and power circuits. In addition, each of the high-frequency transmission lines 10 and 10a to 10c may be used to connect two high-frequency circuit boards.

Still further, through-hole conductors obtained by plating inner circumferential surfaces of through-holes may be used in the high-frequency transmission lines 10 and 10a to 10c in place of the via-hole conductors as described above.

Yet further, in the high-frequency transmission lines 10 and 10a to 10c, the ground conductors 22 and 24 preferably are provided in the dielectric element assembly 12, for example, but they may be provided either on the top surface or the bottom surface of the dielectric element assembly 12.

Note that the high-frequency transmission lines 10 and 10a to 10c may be used on RF circuit boards such as antenna front end modules.

Further, the connectors 100a to 100d do not have to be mounted on the high-frequency transmission lines 10 and 10a to 10c. In such a case, the high-frequency transmission lines 10 and 10a to 10c are connected at the ends to circuit boards by soldering or suchlike. Alternatively, the connectors 100a to 100d may be mounted on some ends of the high-frequency transmission lines 10 and 10a to 10c.

Still further, the connectors 100a to 100d are mounted on the top surfaces of the high-frequency transmission lines 10 and 10a to 10, but they may be provided on the bottom surfaces. Alternatively, for example, the connectors 100a and 100b may be mounted on the top surfaces of the high-frequency transmission lines 10 and 10a to 10c, and the connector 100c and 100d may be mounted on the bottom surfaces of the high-frequency transmission lines 10 and 10a to 10c.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1. (canceled)

2. A high-frequency transmission line comprising:
a laminate including a plurality of dielectric layers;
a first signal line provided on one of the dielectric layers;
a second signal line crossing the first signal line when viewed in a plan view in a direction of lamination, the second signal line being positioned on the same dielectric layer as the first signal line except for a crossing portion that crosses with the first signal line; and
an intermediate ground conductor provided between the first and second signal lines in the direction of lamination, so as to overlap with crossing portions of the first and second signal lines when viewed in a plan view in the direction of lamination.

3. The high-frequency transmission line according to claim 2, wherein
the crossing portion of the first signal line that crosses the second signal line is positioned on a second side in the direction of lamination relative to a portion of the first signal line not crossing the second signal line; and
the crossing portion of the second signal line that crosses the first signal line is positioned on a first side in the direction of lamination relative to a portion of the second signal line not crossing the first signal line.

4. The high-frequency transmission line according to claim 2, further comprising:
a first ground conductor positioned on the first side in the direction of lamination relative to portions of the first and second signal lines not crossing each other; and
a second ground conductor positioned on the second side in the direction of lamination relative to portions of the first and second signal lines not crossing each other.

5. The high-frequency transmission line according to claim 4, wherein
an overlap of the first signal line with the second ground conductor is smaller in area than an overlap of the first signal line with the first ground conductor;
an overlap of the second signal line with the second ground conductor is smaller in area than an overlap of the second signal line with the first ground conductor; and
the portions of the first and second signal lines not crossing each other are less distant from the second ground conductor in the direction of lamination than from the first ground conductor in the direction of lamination.

6. The high-frequency transmission line according to claim 5, wherein the second ground conductor includes a plurality of first openings arranged along the first signal line and a plurality of second openings arranged along the second signal line.

7. The high-frequency transmission line according to claim 3, wherein
the crossing portion of the first signal line that crosses the second signal line is positioned on the second side in the direction of lamination relative to the second ground conductor; and
the intermediate ground conductor is a portion of the second ground conductor overlapping with the crossing portions of the first and second signal lines.

8. The high-frequency transmission line according to claim 4, wherein openings are provided in the second ground conductor, the first and second signal lines have different widths, and the intermediate ground conductor is provided only at the crossing portions of the first and second signal lines.

9. The high-frequency transmission line according to claim 4, wherein the intermediate ground conductor is defined by a portion of the second ground conductor.

10. An electronic device comprising the high-frequency transmission line according to claim 2.

11. The electronic device according to claim 10, wherein the electronic device is one of a phone, a computer and a camera.

12. An electronic device comprising:
a high-frequency transmission line; and
a housing accommodating the high-frequency transmission line; wherein
the high-frequency transmission line includes:
a laminate including a plurality of dielectric layers;
a first signal line provided on one of the dielectric layers;
a second signal line crossing the first signal line when viewed in a plan view in a direction of lamination, the second signal line being positioned on the same dielectric layer as the first signal line except for a crossing portion that crosses with the first signal line; and
an intermediate ground conductor provided between the first and second signal lines in the direction of lamination, so as to overlap with the crossing portions of the first and second signal lines when viewed in a plan view in the direction of lamination.

13. The electronic device according to claim 12, wherein
the crossing portion of the first signal line that crosses the second signal line is positioned on a second side in the direction of lamination relative to a portion of the first signal line not crossing the second signal line; and
the crossing portion of the second signal line that crosses the first signal line is positioned on a first side in the direction of lamination relative to a portion of the second signal line not crossing the first signal line.

14. The electronic device according to claim 12, further comprising:
a first ground conductor positioned on the first side in the direction of lamination relative to portions of the first and second signal lines not crossing each other; and
a second ground conductor positioned on the second side in the direction of lamination relative to portions of the first and second signal lines not crossing each other.

15. The electronic device according to claim 14, wherein
an overlap of the first signal line with the second ground conductor is smaller in area than an overlap of the first signal line with the first ground conductor;
an overlap of the second signal line with the second ground conductor is smaller in area than an overlap of the second signal line with the first ground conductor; and
the portions of the first and second signal lines not crossing each other are less distant from the second ground conductor in the direction of lamination than from the first ground conductor in the direction of lamination.

16. The electronic device according to claim 15, wherein the second ground conductor includes a plurality of first openings arranged along the first signal line and a plurality of second openings arranged along the second signal line.

17. The electronic device according to claim 13, wherein
the crossing portion of the first signal line that crosses the second signal line is positioned on the second side in the direction of lamination relative to the second ground conductor; and
the intermediate ground conductor is a portion of the second ground conductor overlapping with the crossing portions of the first and second signal lines.

18. The electronic device according to claim 14, wherein openings are provided in the second ground conductor, the first and second signal lines have different widths, and the intermediate ground conductor is provided only at the crossing portions of the first and second signal lines.

19. The electronic device according to claim 14, wherein the intermediate ground conductor is defined by a portion of the second ground conductor.

20. The electronic device according to claim 12, wherein the electronic device is one of a phone, a computer and a camera.
